(19) United States
(12) Patent Application Publication
(10) Pub. No.: US 2025/0297069 A1
(43) Pub. Date: Sep. 25, 2025

(54) TREATMENT STRATEGIES TO PROTECT FLOWABLE POLYMER BODIES AGAINST BLOCKING AND FOULING

(71) Applicant: Ecolab USA Inc., St. Paul, MN (US)

(72) Inventors: Kameswara R. Vyakaranam, Sugar Land, TX (US); Ashish Dhawan, Aurora, IL (US); Omer Gul, Rosenberg, TX (US); Carter Martin Silvernail, Lakeville, MN (US); Bassam Kamal Alnasleh, Sugar Land, TX (US)

(21) Appl. No.: 18/676,988

(22) Filed: May 29, 2024

Related U.S. Application Data
(60) Provisional application No. 63/568,681, filed on Mar. 22, 2024.

(51) Int. Cl. C08J 3/12

(52) U.S. Cl. CPC C08J 3/124; C08J 3/126; C08J 2371/02; C08J 2383/04

(57) ABSTRACT

The present invention provides aqueous treatment strategies that use ingredients comprising at least an EO/PO nonionic surfactant (defined below), optionally in combination with EO (defined below) and/or EO/BO nonionic surfactants (defined below) and/or other optional ingredients, to reduce blocking, frothing (i.e., foaming) in aqueous media if desired, and fouling problems associated with flowable solid polymer bodies such as powders, granules, grains, pellets, chunks, particles, combinations of these and the like. The aqueous treatment strategies are particularly useful in polymer pellet fabrication.

### CROSS REFERENCE TO RELATED APPLICATION

This application claims the benefit of U.S. Provisional Patent Application Ser. No. 63/568,681, filed Mar. 22, 2024, the disclosure of which is incorporated in its entirety herein by reference for all purposes.

### FIELD OF THE INVENTION

The present invention is directed to aqueous treatment compositions that can be used to treat polymer bodies and/or equipment surfaces in order to help protect against blocking, agglomeration, and/or fouling associated with the polymer bodies. More specifically, the aqueous treatment compositions include a first surfactant component including at least one EO/PO nonionic surfactant including ethylene oxide and propylene oxide groups and optionally a second surfactant component comprising at least one additional nonionic surfactant component. In some embodiments, the aqueous treatment compositions are used to treat polymer pellets.

### BACKGROUND OF THE INVENTION

A polymer may be provided in the form of a plurality of solid, flowable bodies such that the polymer bodies are able to flow, be transported, be poured, be fluidized, or otherwise handled in solid form in a way that mimics to a degree how a liquid can be handled. Flowable polymer solids provide several advantages over molten forms in many contexts. For example, flowable polymer solids are easy to handle at relatively lower temperatures. Flowable solids may be caused to flow at ambient or even colder temperatures, while the same or other polymers if not in the form of flowable bodies may need to be heated to elevated temperatures to be flowable in liquid or molten form. Even if liquid media might be used at one or more stages in the manufacture, transport, packaging, use, and/or the like of flowable polymer solids, solid, flowable materials may be used without requiring any solvent or liquid carrier, although some kind of liquid carrier could still be used in some instances if desired. Packing and transport of flowable solids in dry form often can be easier than for liquid media, as is clean up.

Flowable polymer bodies may be provided in a wide range of sizes suitable for the desired end use. For example, flowable polymer bodies in some instances may have sizes ranging from 0.1 microns or greater. Materials that are smaller or even larger than this can be used in other instances. Supplies may be processed, such as by screening or the like, to help limit a particular supply to one or more particular size ranges and/or distributions.

Flowable solid polymer bodies may be provided in a variety of physical forms such as powder, pellets, granules, chunks, grains, spheroids, other particle forms, combinations of these, and the like.

According to an illustrative mode of practice, flowable solid polymer bodies referred to in the plastic industry as polymer pellets are widely used as a source material for fabricating polymer articles. For example, polymer pellets may be held in a hopper or other suitable supply containment and then allowed or caused to flow into an extruder, injection molding apparatus, calendaring apparatus or the like in order to form desired articles, optionally in combination with other ingredients.

Polymer pellets may be produced in a variety of ways, including by an extruder-pelletizer strategy in which an extrudate is subdivided in a manner to form relatively smaller sized, flowable, solid polymer pellets. Sometimes, by-products in the form of larger pieces or fines also may be formed. In some cases, these can be left in admixture with the pellets. In other cases, the by-products are removed.

Examples of extrusion and pelletizing processes include melt pelletizing and strand pelletizing. In melt pelletizing, a hot polymer melt emerging from an extruder die may almost immediately be subdivided into pellet form while still in a molten or partially molten state and then subsequently cooled to form the solid pellets. In strand pelletizing, a strand of polymer melt may be drawn into a cooling water tank and cooled to solid form, whereupon it is then pelletized by a pelletizer. Variations of these methods exist. In an underwater hot-cut method, a molten, thin rod-shaped polymer may be extruded from an extruder, drawn into a water tank, cooled, and then pelletized by a pelletizer. In a water-cooled hot-cut method, molten resin may be extruded and pelletized by cutting under sprayed cooling water.

In the aforementioned methods, aqueous liquid media or other cooling media (e.g., another liquid or a gas) may be used as a coolant to cool the hot extrudate and/or hot pellets sufficiently to provide solid, flowable pellets. When an aqueous liquid medium or other liquid is used as a coolant, the liquid and pellets often are subsequently separated. The separated pellets then can be further dried such as by being heated in an oven or on a heated conveyor. The cooling liquid having absorbed heat from the hot polymer material, thus becomes heated itself. In some methods, the heated water is cooled, such as in a heat exchanger, and then recirculated to be used to cool more pellet product.

The resulting pellets may be handled or otherwise used in a variety of ways. Often, the pellet product is initially transported to a dryer and/or a storage silo before being deployed for packaging, transport, or other further use such as for use in the fabrication of polymer articles or the like.

Several problems may be encountered in the production, processing, and/or handling of flowable polymer bodies such as pellets. For example, in an extrudate-cooling water recirculation system, when pellets are separated from the cooling medium, not all of the pellets are separated. Some pellet material, possibly including fines (smaller sized polymer pieces such as those having a diameter in the longest dimension of under 500 microns, or even under 100 microns, or even under 10 microns, or even finer) may remain in the separated cooling liquid. The polymer remainder tends to be entrained in and circulate with the cooling liquid. If unduly tacky, the remainer could adhere to other remainder material or could adhere to and foul containment system surfaces that the liquid medium contacts. Such fouling is a type of blocking in which the polymer material has a tendency to unduly adhere to other polymer material and/or other surfaces that contact the polymer material. Equipment, tools, pipes, valves, neck-points or any surface contacting the liquid may become fouled and even blocked. Pelletizing operations may have to be shut down in order to clean and decontaminate surfaces, clean or replace cooling media, remove blockages, and the like.

Furthermore, the separated polymer pellets even when dried may block with each other or foul surfaces contacted by the pellet. That is, the pellets may have a tendency to show undue adhesion among pellets or with surfaces and/or friction that may prevent or otherwise impair the movement of a pellet against another pellet or surface. Such blocking and fouling may occur during any pellet handling and processing, such as during pelletizing, drying, storing, transporting, fluidizing, packing, molding, article fabrication, or the like. Blocking and fouling may become worse when the pellets or surfaces are at increasingly higher temperatures, particularly for temperatures near, at or above the glass transition temperature of the pellets. Blocking and fouling are encountered particularly frequently in containments such as conveyors, piping, silos, and the like where inter-pellet blocking and pellet-containment surface adhesion can result in pellets not flowing freely or even being unduly difficult to remove from the containment. There is a strong need to protect flowable polymer materials and contacting surfaces against undue blocking and fouling.

Additives are available for addition to cooling water that contact the pellets in order to treat the surfaces in a manner effective to alleviate blocking and fouling problems. For example, combinations of a lubricant and a nonionic surfactant may be added to cooling water to reduce the blocking and fouling tendencies of pellets. However, some treatments utilizing surfactants may produce too much foaming when added to aqueous cooling liquids. Foaming of the cooling liquid is undesirable, because pellet treatments may be less effective and pellet production efficiency may be reduced.

One example of a successful and effective commercial practice has used combinations of a polysiloxane-modified silica sols with ethoxylated fatty alcohol to prevent or reduce blocking, aggregation, fouling, and other problems with flowable polymer bodies such as polymer pellets. In practice, aqueous admixtures of these have been separately injected into process water generally at the same location, but also these could be combined in the same admixture and then co-injected. This additive combination not only reduces blocking but also is relatively low-foaming. Such additives have been added to, for example, cooling water in extrusion-pelletization processes, wherein the additives may dissolve or, if not fully soluble, disperse in the cooling water. The treated cooling water contacts the pellets, causing the additives to surface treat the pellets. When the treated pellets are separated from the cooling water and subsequently dried, the additives or derivatives thereof may coat or otherwise interact with at least a portion of the surface of the pellets to provide a surface treatment that alleviates problems such as blocking and fouling. Consequently, pellets treated with polysiloxane-containing materials may have polysiloxane-containing materials and ethoxylated fatty alcohols located on the pellet surface to provide this surface effect.

Polysiloxane-containing materials are relatively expensive and can be difficult to obtain in desired quantities from commercial sources. It would be desirable to use less expensive, alternative materials to replace some or even all of the polysiloxane materials used in these surface treatments. Unfortunately, it is difficult to formulate alternative surface treatments with less expensive, easier to source materials that are able to sufficiently mimic or even exceed the ability of polysiloxane materials to protect against problems such blocking, and fouling without causing undue foaming, particularly with regard to aqueous cooling media used to prepare polymer pellets. In particular, some materials that protect against blocking and fouling may tend to cause excessive foaming. Other materials foam less but do not provide enough protection against blocking and fouling.

Accordingly, it would be an advantage if additives were available to reduce or eliminate the aforementioned problems associated with flowable polymer bodies such as in the context of polymer pellet handling, storage, production, transport, and processing, that could generate relatively low amounts of foam, provide protection against blocking and fouling, and that are available to be used in combination with or as an alternative to polysiloxane-containing materials.

### SUMMARY OF THE INVENTION

The present invention provides strategies that use ingredients comprising at least an EO/PO nonionic surfactant (defined below), optionally in combination with EO (defined below) and/or EO/BO nonionic surfactants (defined below) and/or other optional ingredients, to reduce blocking, frothing (i.e., foaming) in aqueous media if desired, and fouling problems associated with flowable solid polymer bodies such as powders, granules, grains, pellets, chunks, particles, combinations of these and the like. The strategies can be used to treat polymer surfaces and/or other surfaces that contact the polymer surfaces. Advantages may include reduction of blocking, frothing, and fouling, and these advantages may be realized with materials that are less expensive and easier to source than current polysiloxane-based materials. This allows the combination of nonionic surfactants of the present invention to be substituted for some or even all of the polysiloxane-based materials used in conventional treatments.

In an illustrative mode of practice, treatment compositions of the present invention may be used to treat polymer pellets to provide treated pellets. Advantageously, in some aspects of this practice, the treatment materials can be incorporated into treatment compositions in the form of aqueous cooling media used in the fabrication of solid, flowable polymer pellets from extruded source polymer material. In these aspects, the source polymer material and/or resultant pellets derived from the polymer material both are cooled as well as treated with the same aqueous media. In the practice of the present invention, this cooling and treatment occurs if desired with relatively low tendency for the aqueous media to froth as might occur in the presence of other surfactant(s).

After contact with an aqueous treatment composition of the present invention followed by drying, the treated polymer pellets tend to be coated or otherwise surface treated with the combination of nonionic surfactants incorporated into the aqueous media. As a consequence, the treated pellets exhibit a lower tendency to block and/or cause equipment fouling than like pellets that have not been treated. For example, the adhesion of a treated pellet to another pellet and/or adhesion and associated fouling of equipment surfaces may be reduced. This helps to protect the flowability characteristics of the solid, polymer bodies such as polymer pellets, making the pellets easier to transport, pour, dispense, package, use, or otherwise handle.

When in the form of aqueous cooling media, such as recirculating aqueous cooling media in a system in which polymer pellets are derived from extruded polymer material, the treatment compositions of the present invention may decrease fouling of surfaces that are contacted by treated, waterborne polymer solid bodies, for example waterborne pellets or corresponding fines that are entrained or otherwise dispersed in the cooling media as the cooling media circulates.

The relatively diluted treatment compositions in the form of aqueous cooling media, sprays for treating surfaces, and the like, optionally may be derived from one or more concentrated embodiments of the treatment compositions or treatment composition precursors that may or may not include a liquid carrier such as an aqueous liquid carrier. A precursor composition refers to a composition that does not include both the first and second nonionic surfactants described herein. A precursor composition may include only one of these nonionic surfactants or neither of these nonionic surfactants. Precursor compositions may be combined with each other and optionally one or more other materials (e.g., additional liquid carrier, other additives, and the like) to form relatively concentrated embodiments of the treatment compositions that subsequently are diluted to form a relatively diluted embodiment that is used to carry out a treatment of polymer material or other surfaces. Alternatively, the precursor compositions and optionally one or more other materials may be combined to directly form the treatment compositions to be used to carry out a treatment without first proceeding through a more concentrated form.

Further, the treatment compositions may be used to protect surfaces against fouling associated with flowable, solid polymer bodies such as the treated, flowable solid polymer bodies of the present invention; flowable, solid polymer bodies treated in other ways; and/or untreated, solid, flowable polymer bodies. A surface treatment of the present invention generally is accomplished by contacting and at least partially coating a surface with a treatment composition of the present invention and then drying or otherwise curing the coating in a manner effective to cause the surface to be more resistant to fouling than an untreated surface. The treatment compositions impart antifouling properties to the surfaces on which the compositions are applied and dried or otherwise cured (e.g., compositions may be ultraviolet curable or the like). The surface treatment may be accomplished in a variety of ways such as by brushing, pouring, spraying, wiping, rolling, laminating, or otherwise applying the treatment composition onto the surface to be protected against fouling and then allowing or causing the surface to dry, optionally with heating although coating and/or drying may occur under ambient conditions or even chilled conditions.

In illustrative modes of practice, in addition to or as an alternative to treating polymer bodies themselves, treatment compositions of the present invention may be used to treat a wide range of surfaces that contact flowable, solid polymer bodies such as extruders, pelletizers, separators, piping, pumps, conveyors, heaters, chillers, containments, and the like. For example, the treatment compositions of the present invention may be added to the spray water used to spray down at least a portion of the interior surfaces of a silo prior to storing flowable, solid polymer pellets in the silo. After application of a treatment composition to one or more interior surfaces of a silo and drying or other curing thereof, the treated interior surfaces show reduced fouling and/or adhesion to polymer pellets contained by the silo and in contact with the pellets. Protection against fouling is further enhanced in those modes of practice in which the flowable polymer bodies also are surface treated in a manner to protect against blocking. Preferably, a surface treatment of the present invention is used on both the polymer material and at least a portion of the surface(s) that contact the polymer material.

In general, many conventional, surfactant-containing, aqueous compositions may be particularly prone to undesired foaming. Foaming of surfactant-containing compositions is undesirable in many instances, because foaming may provide difficulties in handling of the surfactant-containing compositions. For example, the compositions may entrain air and occupy undue space in pipes and/or storage vessels. Foamed compositions may be difficult to pump because of the entrained air. Further, foamed compositions may provide reduced contact between flowable polymer bodies and surfactant and less protection against fouling and/or blocking of the polymer bodies. Because the treatments of the present invention have improved resistance to foaming, they are particularly well-suited for use in aqueous media such as in aqueous spray applications for surfaces to impart anti-fouling properties thereto. Further, foaming may be a severe problem in prior-art treatment compositions added to aqueous cooling media in polymer extrusion processes, for example during cooling of extruded polymer material and/or pellets derived therefrom, centrifugal separation of recirculated, aqueous cooling media, combinations of these, and the like. Accordingly, the treatment compositions described herein are also particularly well-suited for addition to cooling water in extrusion and other aqueous media used in the fabrication, processing, or other handling of flowable, solid, polymer bodies.

In one aspect, the present invention relates to a method of treating a plurality of solid polymer bodies, comprising the step of causing the plurality of solid polymer bodies to contact an aqueous treatment composition, wherein the aqueous treatment composition comprises:
a) an aqueous liquid carrier;
b) a first surfactant component comprising at least one EO/PO nonionic surfactant comprising a hydrophobic moiety, a plurality of ethylene oxide groups, and a plurality propylene oxide groups, wherein the at least one EO/PO nonionic surfactant comprises 5 weight percent or more of the propylene oxide groups based on the total weight of the EO/PO nonionic surfactant; and
c) a second surfactant component comprising at least one EO nonionic surfactant comprising a hydrophobic moiety and a plurality of ethylene oxide groups, wherein the at least one EO nonionic surfactant is free of propylene oxide groups; and
   wherein the aqueous treatment composition is at a temperature below the solid transition temperature associated with the plurality of solid polymer bodies.

In another aspect, the present invention relates to a method of treating a plurality of polymer bodies having an associated solid transition temperature, comprising the step of causing the plurality of polymer bodies to contact an aqueous treatment composition, wherein the aqueous treatment composition comprises:
a) an aqueous liquid carrier; and
b) a first surfactant component comprising at least one EO/PO nonionic surfactant comprising a hydrophobic moiety, a plurality of ethylene oxide groups, and a plurality propylene oxide groups, wherein the molar ratio of the propylene oxide groups to the ethylene oxide groups is greater than 1, and wherein the at least one EO/PO nonionic surfactant comprises 5 weight percent or more of the propylene oxide groups based on the total weight of the EO/PO nonionic surfactant; and
   wherein the aqueous treatment composition is at a temperature below the solid transition temperature associated with the plurality of solid polymer bodies.

In another aspect, the present invention relates to a method of making solid polymer pellets having an associated solid transition temperature, comprising the steps of:
a) introducing one or more molten polymer strands into a volume comprising an aqueous composition, wherein the aqueous composition comprises an aqueous liquid carrier and a first surfactant component comprising at least one EO/PO nonionic surfactant comprising a hydrophobic moiety, a plurality of ethylene oxide groups, and a plurality of propylene oxide groups, wherein the aqueous treatment composition at the time of said introducing is at a temperature sufficiently below the associated solid transition temperature so as to be effective to cause the one or more molten polymer strands to solidify in the aqueous treatment composition, and wherein the at least one EO/PO nonionic surfactant comprises 5 weight percent or more of the propylene oxide groups based on the total weight of the at least one EO/PO nonionic surfactant; and
b) while the one or more solidified polymer strands are in the volume comprising the aqueous composition, pelletizing the one or more solidified polymer strands.

In another aspect, the present invention relates to a storage system, comprising:
a) a storage vessel comprising an internal surface defining at least a portion of a storage volume, wherein the surface includes a surface treatment comprising a first surfactant component, wherein the first surfactant component comprises at least one EO/PO nonionic surfactant, wherein the at least one EO/PO nonionic surfactant comprises a hydrophobic moiety, a plurality of ethylene oxide groups, and a plurality of propylene oxide groups, and wherein the at least one EO/PO nonionic surfactant comprises 5 weight percent or more of the propylene oxide groups based on the total weight of the at least one EO/PO nonionic surfactant; and
b) a plurality of polymer bodies held in the storage volume such that at least a portion of the polymer bodies contact the internal surface.

In another aspect, the present invention relates to a method of storing polymer bodies, comprising the steps of:
a) providing a storage vessel comprising an internal surface defining at least a portion of a storage volume, wherein the internal surface includes a surface treatment comprising a first surfactant component, wherein the first surfactant component comprises at least one EO/PO nonionic surfactant that comprises a hydrophobic moiety, a plurality of ethylene oxide groups, and a plurality of propylene oxide group, and wherein the at least one EO/PO nonionic surfactant comprises 5 weight percent or more of the propylene oxide groups based on the total weight of the at least one EO/PO nonionic surfactant; and
b) holding a plurality of polymer bodies in the storage volume such that at least a portion of the polymer bodies contact the internal surface.

### BRIEF DESCRIPTION OF THE FIGURES

FIG. 1 is a schematic of an illustrative system useful to produce polymer pellets whose features and use incorporates principles of the present invention.

FIG. 2 is a schematic illustration of a treatment to spray a surface according to embodiments of the invention.

FIG. 3 is a schematic illustration of a coated surface resulting from the treatment of FIG. 2.

FIG. 4 shows a table of weight variance and volume variance with respect to polymer pellets soaked in water and in surfactant-containing compositions in accordance with Example 4 herein.

FIG. 5 shows a graph of surface tension as a function of time with respect to water and surfactant-containing compositions in accordance with Example 5 herein.

### DETAILED DESCRIPTION OF PRESENTLY PREFERRED EMBODIMENTS

Although the present disclosure provides references to various embodiments, persons skilled in the art will recognize that changes may be made in form and detail without departing from the spirit and scope of the application. Various embodiments will be described in detail with reference to the figures. Reference to various embodiments does not limit the scope of the claims attached hereto. Additionally, any examples set forth in this application are illustrative and are not intended to be limiting and merely set forth some of the many possible embodiments for the appended claims.

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present application. All publications, patent applications, patents and other references mentioned herein are incorporated by reference in their respective entireties and for all purposes.

As used herein, the terms “comprise(s),” “include(s),” “having,” “has,” “can,” “contain(s),” and variants thereof are intended to be open-ended transitional phrases, terms, or words that do not preclude the possibility of additional acts or structures.

The singular forms “a,” “and” and “the” include plural references unless the context clearly dictates otherwise.

As used herein, the term “optional” or “optionally” means that the described subject matter (e.g., feature, condition, step, event or circumstance, or the like) may but need not occur, and that use thereof includes instances where the subject matter occurs and instances in which it does not.

As used herein, any recited ranges of values contemplate all values within the range and are to be construed as support for claims reciting any sub-ranges having endpoints which are real number values within the recited range. By way of example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5; and fractions thereof e.g. 1.5-3.5, 1.7-4.8, etc.

The present invention provides systems, methods, and treatment compositions useful for treating polymer bodies, particularly flowable, solid polymer bodies, in order to help protect against blocking, fouling, and/or agglomeration of the polymer bodies to themselves or to other surfaces. Advantageously, the treatment compositions have low foaming characteristics. Principles of the present invention are particularly useful when integrated with systems and methods for treating, processing, transporting, packaging, storing, dispensing, using, or otherwise handling polymer pellets in extrusion-pelletization processes.

A polymer body generally comprises at least one polymer and/or oligomer optionally in combination with one or more other ingredients (described further below). A polymer body may comprise a plurality of polymers and/or a plurality of oligomers. As used herein, an oligomer refers to a compound incorporating 2 to 30 monomer units. As used herein, a polymer refers to a compound incorporating 31 or more monomer units. Some polymers, such as ultrahigh molecular weight polyolefins, may incorporate millions of monomer units. In many illustrative embodiments, polymers incorporate at least 50 or even at least 100 monomer units. In many illustrative embodiments, polymers incorporate as many as 200 monomer units, or even 500 monomer units, or even 1000 monomer units, or even 10,000 monomer units, or even 100,000 monomer units, or even 1,000,000 monomer units, or even 3,000,000 monomer units. For purpose of this invention, terminal groups that do not have dual or higher functionality to allow oligomerization or polymerization are not monomer units. For example, a compound incorporating 10 monomer units and two terminal, monovalent moieties is considered to have 10 monomer units, and thus is an oligomer.

Oligomers and polymers useful in polymer bodies may incorporate one or more different kinds of monomer units. The terminology “copolymer” refers to polymers and oligomers incorporating two or more different kinds of monomer units. The terminology “copolymer” therefore includes polymers and oligomers including two types of monomer units, three types of polymer units (terpolymers), four types of monomer units (quadrapolymers), and polymers comprising five or more types of monomer units.

For convenience, the terminology “polymeric material” or the plural thereof refers to polymers and oligomers collectively unless expressly stated otherwise. Similarly, the terminology “polymer body” or the plural thereof encompasses a body or bodies, as the case may be, incorporating at least one polymer and/or at least one oligomer.

A wide variety of polymeric materials may be used in polymer bodies. Polymeric materials may be natural or synthetic. Some polymer bodies may include only one or more natural polymeric materials. Some polymer bodies may include only one or more synthetic polymeric materials. Some polymer bodies may include one or more natural polymeric materials and one or more synthetic polymeric materials.

A polymeric material may have a variety of backbone configurations including linear, branched, cyclic, and combinations of these. A polymeric material may be saturated (no carbon-carbon double bonds) or unsaturated (includes one or more carbon-carbon double or triple bonds). Polymeric material may be aliphatic or aromatic. A polymeric material may include backbone or pendant functionality such as hydroxyl, amine, carbon-carbon double or triple bonds, ether, ester, nitrile, epoxide, carboxylate, sulfonate, phosphate, quaternary ammonium, thio, phenyl, hydrocarbyl, metal atom-containing functionality, combinations of these, and the like. In some embodiments, backbone(s) or pendant moieties of an organic polymeric material may include only carbon atoms or may include carbon atoms as well as one or more non-carbon atoms such as Si, B, P, S, N, and/or O. For example, some inorganic polymeric materials have a backbone that includes Si atoms and optionally one or more heteroatoms such as P, S, N, and/or O, preferably N and/or O.

Illustrative examples of suitable polymeric materials include polyethylene; polystyrene; polypropylene; other olefin polymers and copolymers such as ethylene-propylene copolymers and ethylene-vinyl acetate copolymers, as well as combinations thereof, polyurethane, polyester, polycarbonate, protein, starch, polyvinyl chloride, fluoropolymer, polyacetal, polyamide, polyimide, poly(meth)acrylate, cellulose, acrylonitrile, polysulfide, polysilane, polysiloxane, polyphosphazene, polyborazylene, polyaminoborane, polythiazyl, polyphosphate, polyborate, combinations of these, and the like. Organic polymeric materials are preferred. A polymeric material useful in the practice of the present may be a thermoset or thermoplastic material.

In some embodiments in which polymer bodies are formed from admixtures containing a combination of more than one kind of polymeric material, the combinations desirably are solid in admixture even if one or more of the constituents might not be a solid material when used alone. Liquid polymeric materials may tend to result in sticky surfaces, affecting operations. It is desirable to avoid using polymeric material ingredients and/or amounts of such ingredients that remain in liquid form under ambient conditions and/or under temperature conditions of treatment media, because polymer bodies that are solid under such conditions are much easier to process, use, transport, package, store, or otherwise handle.

Polymeric materials used in polymer bodies at 1 atm of pressure desirably exist in solid form at temperatures at least in a temperature range up to 60° C., or even in a temperature range up to 70° C., or even in a temperature range up to 80° C., or even in a temperature range up to 90° C., or even in a temperature range up to 97° C. such as in the range from 5° C. to 98° C. This would mean that the polymer bodies would tend to exist in solid form in aqueous treatment compositions that are at temperatures in these temperature ranges. Further, in some modes of practice in which polymer bodies are made in processes (e.g., extrusion, injection molding, spraying, etc.) in which the polymer bodies are derived from polymer material(s) in molten form, the molten material would tend to cool and solidify when contacted with aqueous treatment compositions at temperatures in these temperature ranges.

Polymer bodies in solid form are less prone to blocking, agglomeration, and fouling than non-solid polymer bodies. Consequently, the aqueous treatment composition is desirably at a temperature such that the polymer bodies when in temperature equilibrium with the aqueous treatment composition are in solid form. As described below, each polymer body and the population of polymer bodies has an associated solid transition temperature. Taking into account that a population of polymer bodies may include more than one associated solid transition temperatures, the aqueous treatment composition desirably is at a temperature that is below, preferably at least 5° C. below, even at least 10° C. below, or even at least 20° C. below the lowest associated solid transition temperature of the polymer bodies.

In the practice of the present invention, determination of solid state of a polymer body may be made by comparing a polymeric body to its associated glass transition temperature(s) and/or associated melting temperature(s). When a polymer body includes a single type of polymeric material, the polymeric material has an associated glass transition temperature (Tg) and/or associated melting temperature (Tm), as applicable. The glass transition temperature (if any) of a polymeric material indicates the transition from a solid state to a softer, more pliable “rubbery” state as the temperature increases. The transition from solid state to a rubbery state tends to occur over a temperature range over which the polymer's mechanical properties change significantly due to increased molecular mobility. The melting point of a polymer is defined as the temperature at which the material transitions from a solid state to a liquid state under atmospheric pressure.

Some polymeric materials have a glass transition temperature but no melting temperature. Others have a melting temperature but no glass transition temperature. Some have both a glass transition temperature and a melting temperature. For example, an amorphous thermoplastic tends to have an associated glass transition temperature but does not have a distinct melting temperature. A crystalline thermoplastic tends to have an associated and distinct melting temperature but does not have a glass transition temperature. Both a glass transition temperature and a melting temperature can be observed for a partially crystalline thermoplastic including both crystalline and amorphous regions.

Thermoset polymers are characterized by their cross-linked molecular structures, which are formed during a curing process that involves chemical reactions. Thermoset polymers tend to exhibit glass transition temperatures, but due to their crosslinked nature do not generally exhibit a melting point. Just as is the case for thermoplastics, the Tg for a thermoset polymer indicates the transition from solid state in which the polymer is relatively hard and relatively more brittle state to a more flexible, softer rubbery state as temperature increases. However, unlike thermoplastics, thermosets do not melt after surpassing their Tg due to the cross-linked network. Upon reaching a temperature threshold as temperature increases, a thermoset material will tend to degrade or burn rather than melt.

Mixtures of more than one polymeric material may exhibit one or more glass transition temperatures and/or one or more melting temperatures. For example, miscible blends of polymeric materials tend to exhibit a single glass transition temperature (if any) and/or melting temperature (if any). Immiscible blends tend to show an associated glass transition temperature (if any) and/or an associated melting temperature (if any) for each immiscible component. Partially miscible blends may exhibit characteristics like a miscible blend or an immiscible blend. For purposes of the present invention, if a mixture shows a single Tg and/or Tm, each of these singular temperature characteristics is taken as the associated Tg (if any) and associated Tm (if any) for the polymer body. If a mixture shows multiple Tg and/or Tm characteristics, the lowest value of Tg and/or lowest Tm is taken as the associated Tg and/or associated Tm for the polymer body, respectively.

For purposes of the present invention, if a polymer body has an associated Tg but no associated Tm, the associated solid transition temperature is deemed to be the associated Tg. If a polymer body has an associated Tm but no associated Tg, then the associated solid transition temperature is deemed to be the associated Tm. If the polymer body has an associated Tg and an associated Tm, then the associated solid transition temperature is deemed to be the associated Tg. If a population of polymer bodies has more than one associated solid transition temperature (such as might occur if polymer bodies with different compositions are present in the population), then the associated solid transition temperature of the population of polymer bodies is taken as the lowest associated solid transition temperature. For purposes of the present invention, a polymer body or plurality of polymer bodies is deemed to be a solid if the polymer body or plurality of bodies is at a temperature below its associated solid transition temperature.

In the practice of the present invention, Differential Scanning calorimetry (DSC) techniques are used to measure the glass transition temperature samples including one or more amorphous or partially crystalline organic and inorganic polymers and/or one or more thermoset polymers in accordance with ASTM E1356-08 (as updated Aug. 11, 2023) titled Standard Test Method for Assignment of the Glass Transition Temperatures by Differential Scanning calorimetry. Generally, the methodology according to this standard involves heating a small sample of the polymer at a controlled rate and measuring the heat flow into or out of the sample relative to a reference. As the polymer transitions from the glassy state to the rubbery state, there is a change in its specific heat capacity, leading to a deviation in the heat flow curve. This deviation is used to determine the glass transition temperature.

In the practice of the present invention, Differential Scanning calorimetry (DSC) techniques are used to measure the melting temperature of samples including one or more crystalline and/or partially crystalline organic and inorganic polymers in accordance with ASTM D3418 (as updated Sep. 17, 2021) titled Standard Test Method for Transition Temperatures and Enthalpies of Fusion and Crystallization of Polymers by Differential Scanning calorimetry (DSC). This test method measures the amount of energy absorbed or released by a sample as it is heated or cooled, allowing for the identification of the melting point,

In addition to polymeric materials, polymer bodies may include one or more other ingredients to help with processing and/or to help protect the polymer bodies or modify the physical, chemical and/or aesthetic properties of the polymer bodies. Illustrative examples of other ingredients include one or more ultraviolet stabilizers, plasticizers, tackifiers, anti-blocking agents, antioxidants, antistatic agents, plasticizers, fillers, colorants, bactericides, fungicides, viscosity modifiers, taggants, combinations of these, and the like.

Polymeric materials may have a molecular weight selected from a wide range. As used herein with respect to polymeric materials, molecular weight refers to the number average molecular weight unless otherwise stated. Preferably, the number average molecular weight is determined using high pressure liquid chromatography (HPLC) techniques. The number average molecular weight of a polymeric material desirably is high enough so that the polymeric material exists as a solid in accordance with the conditions explained above. Exemplary polymeric materials suitable for use in solid polymeric bodies would be those that have a number average molecular weight of at least 500, or at least 750, or at least 1500, or at least 2500. A useful polymeric material may have a number average molecular weight of up to 5000 or more, even 10,000 or more, even 25,000 or more, even 100,000 or more, or even in a range from 1,000,000 to 10,000,000. For example, solid polymeric materials, such as ultrahigh molecular weight polyethylene, may have number average molecular weights in the millions, such as from 3.5 million to 7.5 million. In some embodiments, a solid polymeric material may have a number average molecular weight in the range from 500 to 10,000,000, or from 750 to 10,000,000, or from 1000 to 10,000,000, or from 2000 to 10,000,000, or from 5000 to 10,000,000.

Polymer bodies may have a variety of forms. Nonlimiting examples of forms for the polymer bodies include powders, dusts, fines, granules, grains, pellets, chunks, other kinds of particles, combinations of these, and the like. Polymer bodies are not particularly limited by shape and may have a single shape or a variety of shapes. Non-limiting examples of shapes of the bodies are irregular shapes, spherical, ovoid, cubic, cuboid, lozenge, cylindrical, pyramidal, ellipsoid, conical, frustoconical, trapezoidal prismatic, shapes approximating to any of the foregoing, any combination thereof, and the like.

In some modes of practice, at least a portion of the polymer bodies are in the form of pellets made by an extrusion-pelletization. A typical polymer pellet may have a length in the range from 0.7 microns to 20 millimeters, or 0.7 microns to 10 millimeters, or 0.7 micron to 5 millimeter. A typical polymer pellet may have a diameter in the range from 0.05 mm to about 20 mm. As used herein a pellet made by an extrusion-pelletization process does not refer to latex/emulsion micelles.

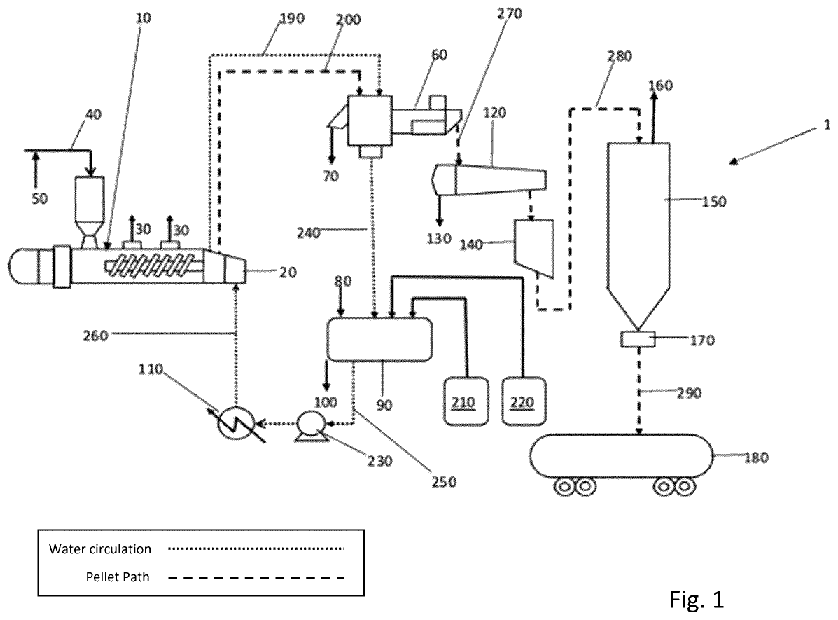

In a representative extrusion-pelletization process to form polymer pellets, the process begins with the extrusion of one or more polymer strands, where the polymer material(s) are heated into a molten state and extruded through a die to create continuous strands of a desired shape. The extruded strands are introduced into a liquid medium which helps to rapidly cool and solidify the strands. In the practice of the present invention, the liquid medium also functions as an aqueous treatment composition. When partially or fully solidified, the strands are chopped into smaller, relatively uniform pieces referred to as pellets. The pellets may be further processed or otherwise handled. Details of how principles of the present invention are integrated into a pelletization process are described further below, including with respect to FIG. 1.

As used herein, “flowable” with respect to solid, polymer bodies refers to the ability of a plurality of solid polymer bodies to collectively flow or be fluidized, such as when being acted upon by one or more forces, for example the force of gravity. For example, solid powders and larger bodies can be poured from packages, containers, or hoppers or even transported in a flowing manner through or into extruders, injection molding machines, conduits, conveyors or the like. Even significantly larger bodies, e.g., gravel or even boulder-sized bodies, can be caused to flow.

In preferred modes of practice, the flowable characteristics of flowable, solid polymer bodies may be evaluated using a Pipe Test. According to the Pipe Test, flowable, solid polymer bodies are deemed to be flowable if a collection containing 1000 bodies has a flow rate of at least 3 polymer bodies per second, or at least 10 polymer bodies per second, or even at least 25 polymer bodies per second downward when dispensed from a hopper under the force of gravity through a polished, stainless steel (304 grade), vertical, cylindrical pipe having a diameter of 20 times the longest size dimension of the polymer bodies being tested.

The polymer bodies may have size distribution characteristics selected from a range of size distribution types. For purposes of illustration, a suitable size distribution may be irregular, monomodal, multimodal such as bimodal, a Gaussian distribution, a Weibull distribution, or other type of distribution of sizes.

Solid polymer bodies may have size characteristics selected from a wide range. In illustrative modes of practice, desired particle size characteristics may depend on factors such as the intended mode(s) of use or other mode(s) of handling, method of fabrication, and the like. For example, particle size can impact reactivity, dissolution, stability in suspension, efficacy of delivery (e.g., asthma inhalers), texture and feel and taste (e.g., food and beverage ingredients), appearance (e.g., powders and inks), flowability, handling, viscosity, packing density, porosity, transportability, mixing, and the like. Size characteristics may be expressed as a size associated with an individual polymer body or as one or more size parameters that characterize a collection of polymer bodies as a whole.

For purposes of the present invention, the size characteristics of pellets formed in extrusion processes are described above. For other types of polymer bodies, the size of an individual particle will be deemed to be the equivalent spherical diameter, d, of a sphere having the same weight and density as the particle, given the weight and density of the particle at 1 atm and a temperature of 25° C. For a collection of particles, the average particle size will be deemed to be the equivalent spherical diameter, D, of a sphere having a weight W and density p′, wherein W is the average weight of N particles in the sample, wherein N is the lesser of 500 or the total number of particles in the sample, and p′ is the density of the population as a whole. In illustrative modes of practice, polymer bodies may have a size, d (individual particle) or D (particle collection) in the range from 0.5 microns (micrometers) to 20 cm, or 1 micron to 10 centimeters, or 1 micron to 5 millimeters, or 1 micron to 1500 microns, or 1 micron to 1000 microns. Fines generally refer polymer bodies having a size d under 500 microns such as in a size range from 0.1 microns to 500 microns.

An initial collection of polymer bodies may be processed to provide one or more collections of polymer bodies that are limited to a specific size range. For example, an initial collection of polymer bodies having particles with sizes d from 0.5 microns to 2 mm may be screened or otherwise processed to provide a collection of polymer bodies having sizes d in the range from 0.5 mm to 1.0 mm. The remainder of the initial collection may be further sorted into other size groups, discarded, recycled, or otherwise handled. Some fabrication techniques, such as pelletizing tend to transform a majority of the precursor material (e.g., extruded strands or sheets) into pellets with a narrow size distribution, although some fines or larger fragments may be present. Optionally, at least a portion of the fines and larger fragments, if present, can be separated from the desired pellets by screening or other suitable techniques.

The present invention provides a method of treating a plurality of polymer bodies. Benefits of the treatment method include protecting the polymer bodies against one or more of blocking, fouling, and/or agglomeration of the polymer bodies to themselves or to other surfaces. According to the method, the treatment is accomplished by causing the plurality of polymer bodies to contact an aqueous treatment composition, wherein the aqueous treatment composition comprises an aqueous liquid carrier, a first surfactant component comprising at least one EO/PO nonionic compound (preferably a surfactant) comprising a hydrophobic moiety, a plurality of ethylene oxide (EO) groups, and a plurality propylene oxide (PO) groups. The treatment composition optionally may include a second surfactant component comprising at least one EO nonionic surfactant comprising a hydrophobic moiety and a plurality of ethylene oxide groups, wherein the at least one EO nonionic surfactant is free of propylene oxide groups. In combination with such a second surfactant component or as an alternative to the second surfactant component, the aqueous treatment compositions optionally may include a polysiloxane modified silica sol.

As used herein, an EO group is a divalent group that has a structure according to the formula —R²—O—, wherein R² is a linear hydrocarbyl moiety having a structure according to the formula —CH₂CH₂—. As used herein, a PO group is a divalent group according to the formula —R³—O—, wherein R³ is a linear or branched hydrocarbyl moiety with three carbon atoms.

Surfactants are amphiphilic molecules, meaning they possess both hydrophobic and hydrophilic (water-attracting) moieties. The hydrophilic part of the surfactant is attracted to water, while the hydrophobic part tends to avoid water and interact with nonpolar substances. The term “hydrophobic” with respect to a moiety (functional group or part) in a surfactant refers to the portion of the molecule that is “water-fearing” or repels water. This characteristic means the hydrophobic moiety does not dissolve well in water but prefers to associate with oils, fats, or air. In the context of surfactants, which are compounds that lower the surface tension between two liquids or between a liquid and a solid, the hydrophobic moiety is typically a long, nonpolar chain, such as a hydrocarbon tail.

In the practice of the present invention an organic, hydrophobic moiety generally includes a plurality of C atoms and optionally one or more heteroatoms selected from O, P, N, and/or S with the proviso that the ratio of carbon atoms to the heteroatoms is 6:1 or more, preferably 8:1 or more, and preferably 12:1 or more. Even more preferably, an organic, hydrophobic moiety has the formula R″O—, wherein R″ is a hydrocarbyl moiety that contains at least 6 carbon atoms or even 6 to 50 carbon atoms, a sufficient number of H atoms to fill the carbon vacancies, and no heteroatoms. Illustrative hydrocarbyl moieties suitable as a hydrophobic moiety may be linear, branched, or cyclic. The hydrocarbyl moieties may be aliphatic or aromatic. The hydrocarbyl moieties may be saturated or unsaturated.

It is believed that the treatment of the present invention coats or otherwise modifies the surfaces of the polymer bodies to help prevent one or more of blocking, fouling, and/or agglomeration among the polymer bodies. It is further believed that the treatment primarily surface treats the polymer bodies without the surfactant(s) of the treatment composition unduly migrating or otherwise transporting into the bulk of the polymer bodies.

Contacting the polymer bodies with the aqueous treatment composition may occur in a variety of ways. Desirably, the contact occurs in a manner effective to help ensure that a sufficient portion of the polymer bodies is adequately coated to accomplish the treatment. Exemplary contact methods include immersing the polymer bodies in the aqueous treatment composition; spraying wherein the aqueous treatment composition is atomized through one or more nozzles and directed onto the pellets, which may be agitated or fluidized to help the spray to coat the polymer body surfaces; curtain coating in which the polymer bodies pass through a falling curtain of the aqueous treatment solution, including wherein the polymer bodies are agitated or fluidized in a manner to help the curtain coat the bodies; combinations of these, and the like. Immersion techniques are particularly suitable in the context of treating polymer bodies in the form of pellets formed in an extrusion-pelletization process.

The aqueous liquid carrier of the aqueous treatment composition includes water and optionally one or more water soluble, organic liquids. The weight ratio of the water to the total amount (if present) of the one or more water soluble, organic liquids may vary over a wide range. In illustrative embodiments, if one or more water soluble, organic liquids are present, the aqueous liquid carrier includes from 0.1 to 50, or even 0.5 to 20, or even 0.5 to 10, or even 0.5 to 5 parts by weight of the one or more water soluble, organic liquids per 100 parts by weight of water.

The water and/or water soluble, organic liquids, if desired, may be purified and/or sterilized. In some modes of practice, the water may be purified in a manner effective to be potable grade and/or pharmaceutical grade. In some modes of practice, the water is purified in a manner effective to be classified into Type I or II classes of the International Organization for Standardization according to ASTM D1193-91.

Examples of purification and sterilization techniques include one or more of distillation, mechanical filtration, capacitive deionization, reverse osmosis, carbon filtering, microfiltration, ultrafiltration, membrane filtration, ultraviolet oxidation, gel filtration, treatment with purifying agents, electrodeionization, demineralization, microporous filtration, electrodialysis; treatment with ozone or other oxidants, combinations of these, and the like. If used, deionization may occur in a variety of ways such as by one or more of co-current deionization, counter-current deionization, mixed bed deionization, combinations of these, and the like.

A wide variety of one or more water soluble, organic liquids may be included in the aqueous composition. Examples include one or more of an alcohol such as ethyl alcohol and/or isopropyl alcohol, acetone, acetonitrile, dimethyl sulfoxide, dimethylformamide, N,N-Dimethylacetamide, ethylene glycol, propylene glycol, glycerol, combinations of these, and the like. If present, desirably such organic liquids are used in a manner so as to be sufficiently inert with respect to the polymer bodies being treated so as to avoid unduly impacting performance characteristics, causing polymer swelling, or the like.

The aqueous liquid carrier desirably is at a temperature that is sufficiently low so that polymer bodies contacted by the aqueous liquid carrier are cooled to a solid state or are maintained in a solid state during at least a portion of the time that the polymer bodies are in contact with the aqueous liquid carrier. For example, if the polymer bodies initially are relatively hot when first contacting the aqueous liquid carrier, the contact cools the polymer bodies sufficiently to help maintain the polymer bodies in a solid state. If the polymer bodies are initially sufficiently cool to be in a solid state, the aqueous liquid carrier desirably is sufficiently cool so as to be below the glass transition temperature(s) of each of the polymeric material(s) included in the polymer bodies to help ensure the solid state is maintained. In some embodiments, the aqueous treatment composition is at a temperature in the range from 5 C to 98 C, or even 20 C to 90 C. In some embodiments, the aqueous treatment composition is at a temperature in the range from 5 C to 60 C or even 25 C to 60 C.

The aqueous treatment composition includes a first surfactant component comprising at least one EO/PO nonionic surfactant comprising a hydrophobic moiety, a plurality of ethylene oxide (EO) groups, and a plurality of propylene oxide (PO) groups. The first surfactant component advantageously helps to reduce surface tension. The first surfactant also provides hydrophobicity characteristics as a result of the PO content. Without wishing to be bound by theory, it is believed that the hydrophobic characteristics help wettability of the treatment medium on the polymer bodies, which in turn is believed to help avoid one or more of sticking, agglomeration, fouling and/or the like. In some illustrative embodiments of the EO/PO nonionic surfactant, the molar ratio of propylene oxide groups to ethylene oxide groups may be in the range from 1:100 to 100:1, 50:1 to 1:50, 1:20 to 20:1, 1:4 to 4:1, 2:4 to 4:1, 3:4 to 4:1, 1:1 to 4:1, 1:4 to 3:1 1:4 to 2:1, or 1:4 to 1:1.

In some embodiments, the molar ratio of the propylene oxide groups to ethylene oxide groups may be beneficially selected to enhance performance characteristics of the aqueous treatment composition. For example, the molar ratio of propylene oxide groups to ethylene oxide groups can impact the cloud point of the aqueous treatment composition. The cloud point of a composition including a nonionic surfactant is the temperature at which the mixture starts to phase-separate, thus becoming cloudy, as the composition is heated and its temperature increases. At the cloud point, the surfactants start to separate out of the solution. This behavior is characteristic of nonionic surfactants containing polyoxyalkylene chains (e.g., EO, PO, and BO chains, defined herein), which exhibit reverse solubility (compared to many other solutes) versus temperature behavior in water and therefore “cloud out” at some point as the temperature is raised. Thus, as used herein, the cloud point of a solution containing the first surfactant component refers to the temperature at which an initially single phase (usually clear) solution becomes turbid or cloudy as the solution is heated to higher temperatures.

Thus, at lower temperatures, the solute (such as a surfactant) is fully dissolved, and the solution remains a single phase. However, as the temperature increases, the solubility of the first surfactant component in the solvent decreases.

In the practice of the present invention, single phase embodiments of the aqueous treatment composition would be more effective at surface treating the polymer bodies in order to better provide benefits such as protection against one or more of blocking, fouling, and/or agglomeration of the polymer bodies to themselves or to other surfaces. Consequently, providing aqueous treatment compositions with higher cloud points allows the aqueous treatment compositions to effectively treat the polymer bodies over a wider temperature range. This is beneficial in extrusion-pelletization processes in which the aqueous treatment composition can also function as a cooling bath into which extruded material is cooled, since cooling is faster when the bath is at lower temperatures.

The present invention appreciates that the molar ratio of propylene oxide to ethylene oxide groups in the EO and PO containing nonionic compound impacts the cloud point of the aqueous treatment composition. Generally, increasing the ethylene oxide content relative to the propylene oxide content tends to raise the cloud point of the composition, meaning that the solution remains a single phase over a wider temperature range.

On the other hand, the ability of the EO/PO nonionic surfactant to protect polymer bodies from blocking, agglomeration, and fouling while being low foaming in aqueous media also would be impacted by the amount of propylene oxide content relative to the ethylene oxide content. For example, although increasing EO content relative to PO content tends to favorably increase the cloud point, increasing the EO content relative to the PO content also tends to increase foaming. A sufficient amount of PO content is needed in order to achieve desired low foaming characteristics. Therefore, it is desirable to consider the propylene oxide content relative to the ethylene oxide content based on consideration of cloud point and foaming factors.

Balancing these concerns, it is desirable in some embodiments that the nonionic compound includes a sufficient amount of PO content such that the molar ratio of PO to EO groups is greater than 1 and such that the cloud point of the aqueous treatment composition is higher than 60 C, or even is higher than 70 C, or even is higher than 80 C, or even is higher than 90 C. For example, in some embodiments the molar ratio of the PO to EO groups is selected such that the molar ratio of PO groups to EO groups is in the range from 1.1:1 to 5:1, or even 1.1:1 to 4:1, or even 1.1:1 to 3:1. On the other hand, a sufficient amount of EO content is included so that the cloud point of the aqueous treatment composition is at least 25° C. or higher, or even at least 40° C. or higher, or even at least 60° C. or higher, or even at least 90° C. or higher, or even at least 98° C. or higher.

The practice of the present invention uses a standardized method to determine the cloud point of an aqueous solution containing one or more surfactants as described in ASTM D2024 (2017), “Standard Test Method for Cloud Point of Nonionic Surfactants.” This method is widely accepted and provides a systematic approach for measuring the cloud point of both pure nonionic surfactants as well as compositions formulated with nonionic surfactants. The method as published states that the test method is limited to those systems in which the visible solubility change occurs over a range of 1 C or less at concentrations of 0.5 to 1.0 weight percent in DI water between 30 C and 95 C. In the practice of the present invention, this specification is modified to encompass a temperature range from 25 C to 95 C. Additionally, this specification is modified to encompass systems for which the visibility change occurs over a range that is greater than 1 C, with the proviso that the cloud point will be deemed to be the temperature at which turbidity first appears. Further, the specification recognizes that some systems may not have any cloud point over the temperature range inasmuch as the system being tested stays a single phase even at the highest temperature of the test range. In the practice of the present invention, this would be desirable, because this means the system could be used over a wide range of temperatures while remaining a single phase. Hence, while it is mindful to have cloud point characteristics in mind, systems without a cloud point in the temperature range of interest are highly desirable.

The general procedure for determining the cloud point using ASTM D2024 involves the following steps:
A) Preparation of the Sample: The surfactant solution is prepared at a specified concentration, typically in a transparent glass test tube or similar container, allowing for easy observation of the solution's clarity.
B) Heating the Solution: The solution is gradually heated at a controlled rate. A water bath, heating block, or similar apparatus may be used to ensure uniform heating of the sample.
C) Observation: As the temperature increases, the solution is regularly observed for the first appearance of turbidity or cloudiness. This observation can be made visually against a dark background with a light source or using an automated instrument designed to detect changes in light transmission through the solution.
D) Temperature Measurement: The temperature at which turbidity first appears is recorded as the cloud point. It is essential to use a precise and accurate thermometer or temperature sensor to ensure the reliability of the measurement.
E) Verification: The test may be repeated to verify the results. It is important to cool the solution back to room temperature or below before reheating for a subsequent test to ensure the surfactant molecules fully dissolve again before the next cloud point determination. In the practice of the present invention, it is desirable to repeat the test a total of three times, wherein the cloud point is taken as the average of the three readings. If any of the three readings is further than two standard deviations from the average, then the data is discarded and a new test is performed a total of 5 times. The average of the five temperature results is then taken as the cloud point.

In an illustrative mode of practice, the EO/PO nonionic surfactant is a nonionic surfactant that has Formula A:

R^{H}—(PO)ₘ-(EO)ₙ—R^{T}

wherein R^{H} is H or a hydrophobic organic moiety comprising 6 to 50 carbon atoms, or even 8 to 20 carbon atoms, and in some embodiments R^{H} has the formula R″O— wherein R″ is a hydrocarbyl moiety as defined above, preferably R″ is a hydrocarbyl moiety selected from the group consisting of alkyl (linear, branched, or cyclic), aryl, alkylaryl, and/or the like, and more preferably R″ is a branched alkyl moiety such as 2-ethylhexyl; PO is a divalent propylene oxide group; EO is a divalent ethylene oxide group; R^{T} is a monovalent terminal moiety such as H or an organic moiety such as a linear, branched, or cyclic moiety comprising 1 to 25 carbon atoms and optionally one or more heteroatoms (e.g., O, N, P and/or S); and each of m and n is independently in the range from 2 to 30. In a population of compounds according to Formula A, the values for m and n may vary among the compounds in the population. Hence, when describing a population, each of m and n in these ranges is the average value for the population. For example, for a population of compounds according to Formula A, each of m and n independently has an average value in the range from 2 to 30.

In illustrative embodiments, a compound according to Formula A may be obtained by propoxylating and then ethoxylating one or more fatty alcohols. In such alkoxylated fatty alcohol(s), R^{H} is R″O, and the nonionic surfactants have a structure in accordance with the following Formula A′:

R″O—(PO)ₘ-(EO)ₙ—R^{T}

wherein R″, R^{T}, m and n are as defined above with respect to Formula A, and wherein R^{T} preferably is H.

The compound of Formula A′ may have Formula B:

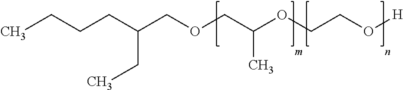

wherein m is 4 to 6 and n is 3 to 15, preferably 3 to 9. In some modes of practice, m is 4 to 6 and n is 3 to 5 with the proviso that m is greater than n (i.e., m>n). As indicated above, for a population of compounds according to Formula B, each of m and n in these ranges is the average value for the population.

In another illustrative mode of practice, the EO/PO nonionic surfactant is a nonionic surfactant that has a structure according to Formula C:

R^{H}—(PO)ₘ-(EO)ₙ—(PO)ₚ—R^{T}

wherein R^{H} is H or a hydrophobic organic moiety comprising 6 to 50 carbon atoms, preferably 8 to 20 carbon atoms and in some embodiments R^{H} has the formula R″O— wherein R″ is as defined above and preferably R″ is a hydrocarbyl moiety selected from the group consisting of alkyl (linear, branched, or cyclic), aryl, alkylaryl, and/or the like, and more preferably R″ is a branched alkyl moiety such as 2-ethylhexyl; each PO is a divalent propylene oxide group; each EO is a divalent ethylene oxide group; R^{T} is a monovalent terminal moiety such as H or an organic moiety such as a linear, branched, or cyclic moiety comprising 1 to 25 carbon atoms and optionally one or more heteroatoms (e.g., O, N, P and/or S); and each of m, n, and p is independently in the range from 2 to 30, or even 12 to 25. Preferably, the molar ratio of PO to EO moieties is greater than 1 on average, i.e., (m+p)>n. In some embodiments, m is in the range from 18 to 22, n is in the range from 12 to 16, and p is in the range from 18 to 22. In a specific example, m is 21, n is 14, and p is 21. In another specific example, m is 21, n is 14, p is 21, and R is a residue of a fatty alcohol comprising 2-ethylhexyl. In a population of compounds according to Formula C, the values for m, n, and p may vary among the compounds in the population. Hence, when describing a population, each of m, n, and p in these ranges is the average value for the population.

In an illustrative embodiment, a compound according to Formula C is obtained by propoxylating, then ethoxylating, and then again propoxylating one or more fatty alcohols. In such alkoxylated fatty alcohol(s), R^{H} is R″O, and the nonionic surfactants have a structure in accordance with the following Formula C′:

R″O—(PO)ₘ-(EO)ₙ—(PO)ₚ—R^{T}

wherein R″, R^{T}, m, n, and p are as defined above with respect to Formula C, and wherein R^{T} preferably is H. In other embodiments, nonionic surfactants according to Formula C may have the following structure according to Formula C″:

H—(PO)ₘ-(EO)ₙ—(PO)ₚ—H

wherein m, n, and p are as defined above with respect to Formula C.

In some modes of practice, the aqueous treatment composition may include a first EO/PO nonionic surfactant according to Formula A, even Formula A′, and a second EO/PO nonionic surfactant according to Formula C, even Formula C′ and/or C″. The relative amounts of the first and second EO/PO nonionic surfactants may be selected from a wide range. For example, in such modes of practice, the molar ratio of the first EO/PO nonionic surfactant to the second EO/PO surfactant is in the range from 1:50 to 50:1, or even 1:10 to 10:1, or even 1:5 to 5:1, or even 1:2 to 2:1.

Suitable EO/PO nonionic surfactants are commercially available. Representative examples include Ecosurf branded nonionic surfactants commercially available from the Dow Chemical Co. such as those sold under trade designations Ecosurf SA-4, Ecosurf SA-7, Ecosurf SA-9, Ecosurf LFE1410, Ecosurf LFE635, Ecosurf EH-3, Ecosurf EH-6; and Pluronic 25R² commercially available from BASF.

In addition to being available from commercial sources, the EO/PO nonionic surfactants can be made according to any suitable synthesis strategy. Illustrative methods for making EO/PO nonionic compounds are widely known and have been described for example in U.S. Pat. Nos. 2,870,220; 3,422,049 3,528,841; 3,682,849; 8,973,668; 10,662,370; 11,291,958; U.S. Pat. Pub. No. 2022/0144740; and PCT Pub. No. WO 01/90240 A1. Synthesis procedures also are described in Chapter 5 of Richard J Farn, Chemistry and Technology of Surfactants, John Wiley & Sons (Apr. 15, 2008).

According to one illustrative reaction scheme for preparing EO/PO nonionic surfactants according to Formulae A, A′, B, C, C′, or C″ a source of the R^{H} moiety is selected. The R^{H} group serves as the lipophilic part of the resulting EO/PO nonionic compound. The EO and PO content introduce hydrophilic groups into the molecule. As an illustrative example, a suitable source of the R^{H} moiety may include one or more fatty alcohols of the formula R″—OH, wherein R″ is as defined above. When using one or more fatty alcohols as a source for the R^{H} moiety, the resultant compound may be referred to as an alkoxylated alcohol.

A wide range of fatty alcohols are suitable in the practice of the present invention with respect to any nonionic surfactants obtained by alkoxylating one or more fatty alcohols. Examples of fatty alcohols suitable in the practice of the present invention include one or more of 2-ethylhexanol, lauryl alcohol, stearyl alcohol, oleyl alcohol, dodecanol, 3-methyl-3-pentanol, 1-heptanol, 1-octanol, 1-nonanol, undecyl alcohol, tridecyl alcohol, myristyl alcohol, pentadecyl alcohol, cetyl alcohol, palmitoleyl alcohol, heptadecyl alcohol, nonadecyl alcohol, arachidyl alcohol, hencicosyl alcohol, behenyl alcohol, erucyl alcohol, lignoceryl alcohol, 1-heptacosanol, montanyl alcohol, 1-nonacosanol, myricyl alcohol, 1-dotriacontanol, geddyl alcohol, combinations of these, and the like.

The fatty alcohol(s) is reacted under controlled conditions with an alkali metal hydroxide to create an active site for further reaction. Next, depending on the desired structure of the desired compound, EO and PO groups are added. To add PO groups, propylene oxide is added to the reaction mixture containing the activated R^{H} moiety. This step typically is carried out under pressure and at a temperature that facilitates the ring-opening addition of the propylene oxide, leading to the incorporation of divalent propylene oxide groups into the molecule. The EO groups are added in a similar fashion using ethylene oxide instead of propylene oxide. The reaction is terminated such as by cooling the reaction mixture and neutralizing remaining active sites. The product is then purified using a suitable method such as distillation or extraction to obtain the desired nonionic compound in a purified form.

In addition to the first surfactant component and the aqueous liquid carrier, the aqueous treatment compositions optionally may include one or more additional ingredients. Illustrative examples of such optional additional ingredients include one or more additional surfactants, anti-foaming agents, anti-blocking agents, anti-flocculation agents, taggants, fungicides, biocides, antistatic agents, antioxidants, UV stabilizers, combinations of these, and the like.

For example, in some embodiments the aqueous treatment composition may further comprise a second surfactant component comprising at least one EO nonionic surfactant. The second surfactant component helps to decrease surface tension and helps to prevent problems such as blocking, aggregation, fouling, and the like. The EO nonionic surfactant comprises a plurality of ethylene oxide groups (defined above) and a hydrophobic moiety. The EO nonionic surfactant may include one or more other kinds of alkylene oxide groups in addition to EO groups, such as butylene oxide (BO) groups, but is free of PO groups. For purposes of the present invention, an EO nonionic compound shall be deemed to be free of PO groups if the compound includes less than 5 weight percent, or even less than 2 weight percent, or even less than 1 weight percent, or even 0 weight percent PO groups based on the total weight of EO and PO groups in the compound. As used herein, a BO group is a divalent group that has the formula —R⁴—O—, wherein R⁴ is a linear or branched hydrocarbyl moiety with four carbon atoms.

In an illustrative mode of practice, the EO nonionic surfactant has Formula D:

R^{H}-(EO)ₙ—R^{T}

herein R^{H} is a hydrophobic organic moiety comprising 6 to 50 carbon atoms, or even 8 to 20 carbon atoms, or even 8 to 16 carbon atoms, and in some embodiments R^{H} has the formula R″O— wherein R″ is as defined above and preferably R″ is a hydrocarbyl moiety selected from the group consisting of alkyl (linear, branched, or cyclic), aryl, alkylaryl, and/or the like, and more preferably R″ is a branched alkyl moiety such as 2-ethylhexyl; EO is a divalent ethylene oxide group; R^{T} is a monovalent terminal moiety such as H or an organic moiety such as a linear, branched, or cyclic moiety comprising 1 to 25 carbon atoms and optionally one or more heteroatoms (e.g., O, N, P and/or S); and n is in the range from 1 to 30, or even 1 to 25, or even 1 to 20 or even 1 to 15 or even 1 to 10. In some embodiments, m is in the range from 5 to 30, or even 5 to 25, or even 5 to 20, or even 5 to 15, or even 5 to 10. In a representative example, n is 7. In illustrative embodiments, the compound according to Formula D is an alkoxylated alcohol obtained by ethoxylating a fatty alcohol. In illustrative embodiments, a compound according to Formula D is obtained by ethoxylating a fatty alcohol. In a population of compounds according to Formula D, the value for n may vary among the compounds in the population. Hence, when describing a population, n in these ranges is the average value for the population.

In illustrative embodiments, a compound according to Formula D may be obtained by ethoxylating one or more fatty alcohols. In such alkoxylated fatty alcohol(s), R^{H} is R″O, and the nonionic surfactants have a structure in accordance with the following Formula D′:

R″O-(EO)ₙ—R^{T}

wherein R″, R^{T}, and n are as defined above with respect to Formula D, and wherein R^{T} preferably is H.

Suitable EO nonionic surfactants according to Formula D are commercially available. Representative examples include surfactants available from available from Dow Chemical Company, Midland, Michigan, USA under the brand name TERGITOL™. Examples include the TERGITOL 15-S range of surfactants. Suitable EO nonionic compounds also are described in Assignee's Co-Pending patent application having Ser. No. 63/470,077, titled Treatment Strategies to Protect Against Blocking and Fouling Associated with Flowable Polymer Bodies, in the names of Vyakaranam et. Al., filed May 31, 2023, and having Attorney Docket No. N11941USP1 (ECO0228/P1), the entirety of which is incorporated herein by reference for all purposes.

In addition to being available from commercial sources, the EO nonionic surfactants can be made according to any suitable synthesis strategy. Illustrative methods for making EO/PO nonionic surfactants are widely known and have been described for example in U.S. Pat. Nos. 2,870,220; 3,422,049 3,528,841; 3,682,849; 8,973,668; 10,662,370; 11,291,958; U.S. Pat. Pub. No. 2022/0144740; and PCT Pub. No. WO 01/90240 A1. Synthesis procedures also are described in Chapter 5 of Richard J Farn, Chemistry and Technology of Surfactants, John Wiley & Sons (Apr. 15, 2008).

According to one illustrative reaction scheme for preparing compounds according to Formula D, a source of the R^{H} moiety is selected. As an illustrative example, a suitable source of the R^{H} moiety may include one or more fatty alcohols (listed above) of the formula R″—OH, wherein R″ is as defined above. When using one or more fatty alcohols as a source for the R^{H} moiety, the resultant compound may be referred to as an alkoxylated alcohol. The R^{H} group serves as the lipophilic part of the resulting EO nonionic compound. The EO content introduces hydrophilic groups into the molecule.

The one or fatty alcohols are reacted under controlled conditions with an alkali metal hydroxide to create an active site for further reaction. Next, ethylene oxide is added to the reaction mixture. This step typically is carried out under pressure and at a temperature that facilitates the ring-opening addition of the ethylene oxide, leading to the incorporation of divalent ethylene oxide groups into the molecule. The reaction is terminated such as by cooling the reaction mixture and neutralizing remaining active sites. The product is then purified using a suitable method such as distillation or extraction to obtain the resultant nonionic compound in a purified form.

In another illustrative mode of practice, the EO nonionic surfactant is an EO/BO nonionic surfactant according to Formula E:

R^{H}—(BO)_{q}-(EO)ₙ—R^{T}

wherein R^{H} is H or a hydrophobic organic moiety comprising 6 to 50 carbon atoms, or even 8 to 20 carbon atoms, or even 8 to 16 carbon atoms, and in some embodiments R^{H} has the formula R″O— wherein R″ is a hydrocarbyl moiety as defined above and preferably R″ is a hydrocarbyl moiety selected from the group consisting of alkyl (linear, branched, or cyclic), aryl, alkylaryl, and/or the like, and more preferably R″ is a branched alkyl moiety such as 2-ethylhexyl; each of BO and EO is as defined above; n is in the range from 1 to 30, or even 1 to 25, or even 1 to 20 or even 1 to 15 or even 1 to 10; and q is in the range from 1 to 30, or even 1 to 25, or even 1 to 20 or even 1 to 15 or even 1 to 10. In some embodiments, each of n and q independently is in the range from 5 to 30, or even 5 to 25, or even 5 to 20, or even 5 to 15, or even 5 to 10. In some illustrative embodiments the molar ratio of butylene oxide groups to ethylene oxide groups in Formula D may be in the range from 1:30 to 30:1, or even 1:20 to 20:1, or even 1:10 to 10:1, or even 1:4 to 4:1. In a population of compounds according to Formula E, the values for n and q may vary among the compounds in the population. Hence, when describing a population, each of m and q in these ranges is the average value for the population.

In illustrative embodiments, the compound according to Formula E is an alkoxylated alcohol obtained by butoxylating and ethoxylating one or more fatty alcohols. In such alkoxylated fatty alcohol(s), R^{H} is R″O, and the nonionic surfactants have a structure in accordance with the following Formula E′:

R″O—(BO)_{q}-(EO)ₙ—R^{T}

wherein R″, R^{T}, q and n are as defined above with respect to Formula E, and wherein R^{T} preferably is H.

Suitable EO/BO nonionic surfactants according to Formula E and E′ are commercially available. Representative examples include surfactants available from available from BASF under the tradename PLURAFAC® such as the PLURAFAC LF 224 and PLURAFAC LF 403 surfactants. Suitable EO/BO nonionic compounds also are described in Assignee's Co-Pending patent application having Ser. No. 63/470,077, titled Treatment Strategies to Protect Against Blocking and Fouling Associated with Flowable Polymer Bodies, in the names of Vyakaranam et. Al., filed May 31, 2023, and having Attorney Docket No. N11941USP1 (ECO0228/P1), the entirety of which is incorporated herein by reference for all purposes.

In addition to being available from commercial sources, the EO/BO nonionic compounds can be made according to any suitable synthesis strategy. Illustrative methods for making EO/BO nonionic compounds are widely known and have been described for example in U.S. Pat. Nos. 2,870,220; 3,422,049 3,528,841; 3,682,849; 8,973,668; 10,662,370; 11,291,958; U.S. Pat. Pub. No. 2022/0144740; and PCT Pub. No. WO 01/90240 A1. Synthesis procedures also are described in Chapter 5 of Richard J Farn, Chemistry and Technology of Surfactants, John Wiley & Sons (Apr. 15, 2008).

According to one illustrative reaction scheme for preparing compounds according to Formula E, a source of the R^{H} moiety is selected. As an illustrative example, a suitable source of the R^{H} moiety may include one or more fatty alcohols of the formula R″—OH, wherein R″ is as defined above. When using one or more fatty alcohols as a source for the R^{H} moiety, the resultant compound may be referred to as an alkoxylated alcohol. The R^{H} group serves as the lipophilic part of the resulting EO/BO nonionic compound. The EO content introduces hydrophilic groups into the molecule.

The one or more fatty alcohols are reacted under controlled conditions with an alkali metal hydroxide to create an active site for further reaction. Next, depending on the desired structure of the desired compound, EO and BO groups are added. To add BO groups, butylene oxide is added to the reaction mixture containing the activated fatty alcohol(s). This step typically is carried out under pressure and at a temperature that facilitates the ring-opening addition of the butylene oxide, leading to the incorporation of butylene oxide groups into the molecule. The EO groups are added in a similar fashion using ethylene oxide instead of butylene oxide. The reaction is terminated such as by cooling the reaction mixture and neutralizing remaining active sites. The product is then purified using a suitable method such as distillation or extraction to obtain the desired nonionic compound in a purified form.

In some modes of practice, the second surfactant component includes a combination of nonionic compounds according to Formulae D (such as D′) and E (such as E′). The relative amounts of the compounds according to Formulae D and E may be selected from a wide range. For example, in such modes of practice, the molar ratio of the compound according to Formula D to the compound according to Formula E is in the range from 1:50 to 50:1, or even 1:10 to 10:1, or even 1:5 to 5:1, or even 1:2 to 2:1.

The weight ratio of the first surfactant component to the second surfactant component may be selected within a wide range. In illustrative modes of practice, the weight ratio of the first surfactant component to the second surfactant component in the treatment composition may be about 1:100 to about 100:1, or 1:20 to 20:1, or 1:5 to about 5:1, or about 1:2 to about 4:1, or about 1:2 to about 3:1, or about 1:2 to about 5:2, or about 1:1 to about 5:2, or about 2:1.

The concentration of each of the first and second surfactant components in the aqueous treatment composition may vary over a wide range based on a variety of factors such as the aqueous treatment composition initially is in the form of a concentrate that is subsequently to be diluted and optionally combined with additional ingredients to provide a final form useful to carry out a desired treatment or whether the treatment composition is formulated in its final form in the first instance. As another factor, separate precursor compositions may be provided and then combined to form the desired aqueous treatment composition in a concentrated form or a diluted form thereof.

For example, relative to the total amount of aqueous liquid carrier, illustrative aqueous treatment compositions useful to treat polymer bodies in the practice of the present may comprise a sufficient amount of each of the first and second surfactants components that is effective to help protect the polymer bodies against blocking, agglomeration and foaming while exhibiting low foaming characteristics. As an example, based on the weight of the aqueous liquid carrier, an aqueous treatment composition may include on a weight basis each of the first and second surfactant components, respectively, at a concentration in the range from 1 ppm to 5 weight percent, or even 5 ppm to 1 weight percent, or even 5 ppm to 3000 ppm, or even 100 ppm to 3000 ppm.

As another optional ingredient, aqueous treatment compositions may include at least one polysiloxane ingredient. As used herein, a polysiloxane ingredient means an ingredient including one or more siloxane moieties. Examples of polysiloxane ingredients include polydimethylsiloxane or a polysiloxane-modified silica. Polysiloxane ingredients have been used in treatment media for polymer pellets and advantageously the treatments provide polymer pellets with excellent protection against blocking, agglomerating, fouling, and the like. Also, polysiloxane ingredients can be formulated into aqueous media that desirably are resistant to foaming. If present, the weight ratio of the polysiloxane ingredient(s) to the first surfactant component may be in the range from 1:10 to 10:1, or 1:5 to 5:1 or 1:2 to 2:1, or 1:10 to 1:1, or 1:1 to 1:10, or 1:1 to 5:1, or 5:1 to 1:1, or about 1:1.

In some embodiments, the aqueous treatment composition includes 1 to 10 parts by weight of the second surfactant component and 1 to 10 parts by weight of polysiloxane ingredient(s) per 1 to 10 parts by weight of the first surfactant component.

However, ingredients comprising polysiloxane are becoming difficult to source and/or are becoming unduly expensive. An advantage of the present invention is that aqueous treatment compositions including the first surfactant component, and particularly a combination of the first surfactant component and the second surfactant component, are able to substantially mimic the performance of treatment media incorporating polysiloxane ingredients without needing to use polysiloxane ingredients. Advantageously, this allows aqueous treatment compositions to use lesser amounts of, and even avoid, polysiloxane ingredients than otherwise might be used to treat polymer pellets. Advantageously, therefore, the amount of polysiloxane ingredients in the aqueous treatment compositions of the present invention is limited or avoided. In such embodiments where the content of the polysiloxane ingredient(s) is limited or avoided, the weight ratio of the polysiloxane ingredient(s) to the first surfactant component is in the range from 0:10,000 to 1:10, or even 0:10,000 to 1:100. More preferably, the aqueous treatment composition does not include polysiloxane ingredients.

In some embodiments, the aqueous treatment compositions of the present invention include the second surfactant component, wherein the second surfactant component includes an ethoxylated fatty alcohol. In addition to such a second surfactant component, the aqueous treatment composition may further comprise a polysiloxane ingredient, wherein the weight ratio of the polysiloxane ingredient to the second surfactant component is in the range from 1:50 to 50:1, or even 1:20 to 20:1, or even 1:50 to 1:10.

In some embodiments, the aqueous treatment compositions of the present invention include the second surfactant component, wherein the second surfactant component includes a) an ethoxylated fatty alcohol and b) a butoxylated fatty alcohol, wherein the weight ration of the ethoxylated fatty alcohol to the butoxylated fatty alcohol is in the range from 1:10 to 10:1. In addition to such a second surfactant component, the aqueous treatment composition may further comprise a polysiloxane ingredient, wherein the weight ratio of the polysiloxane ingredient to the second surfactant component is in the range from 1:50 to 50:1, or even 1:20 to 20:1, or even 1:50 to 1:10.

Various methods may be used to prepare aqueous treatment compositions of the present invention. For example, the first surfactant component and optionally one or more other desired ingredients (if any) may be dissolved, dispersed or otherwise incorporated into the aqueous liquid carrier in a form effective for the desired end use. The ingredients may be incorporated into the aqueous liquid carrier in any order. In preferred embodiments, the aqueous treatment compositions include both the first surfactant component and the second surfactant component.

Treatment compositions of the present invention also may be derived from one or more concentrates comprising the first surfactant component and other ingredients that are combined and/or further diluted to provide the desired aqueous treatment composition. Alternatively, aqueous treatment compositions may be formulated from two or more precursor compositions in which the first and second surfactant components initially are supplied in separate admixtures which later are combined with each other and optionally one or more other ingredients to form aqueous treatment compositions of the present invention. Concentrates and precursor compositions may or may not include the aqueous liquid carrier component of the resulting aqueous treatment compositions.

In an illustrative example, first and second precursor compositions may be provided as a kit. The kit comprises a first kit component comprising the first surfactant component, optionally in a concentrated form. A second kit component comprises the second surfactant component, optionally in a concentrated form. The first and second kit components may be combined to form at a least a portion of the desired aqueous treatment composition. In a specific example, controlled amounts of the first and second kit components are injected into a bath comprising aqueous carrier liquid.

The principles of the present invention are particularly useful in a method for treating polymer bodies in the form of polymer pellets in the context of an extrusion-pelletization process. The process of the present disclosure affords production of stable, extruded polymer pellets without undue compromise of desirable physical property and/or performance attributes, such as elasticity and/or adhesion. The process produces extruded pellets having low surface energy surfaces that substantially reduce or prevent the likelihood of agglomeration during handling, shipping and storage.

Generally, such a method includes melting a thermoplastic polymer to form a polymer melt. The molten polymer is extruded through a die to form an extrudate in the form of one more polymer strands. The molten strands are extruded into an aqueous treatment composition of the present invention in the form of a bath that also serves to cool the molten polymer strands, thereby causing the molten polymer strands to solidify. The water bath is maintained at a temperature substantially lower than that of the molten extrudate. A preferred water bath temperature is typically in the range from about 20° C. to about 90° C. The first and second surfactant components desirably have compositions so that the bath stays as a single phase and is below the cloud point of the bath.

The thermoplastic polymer can be melted and extruded in any type of extruder known in the art, such as a single screw extruder, a twin-screw extruder, and a ram extruder. Extruders may also be used in series with mixers, if desired. Additives may also be added to the polymer matrix by addition to the extruder and/or mixer. The average size or diameter of the strands is not critical and will typically vary from about 0.05 mm to about 20 mm in illustrative modes of practice.

The bath desirably includes the first surfactant component, and more preferably the bath includes both the first surfactant component and the second surfactant component. The bath may include other optional ingredients such as those described above with respect to the aqueous treatment compositions of the present invention. The solidified polymer strands are pelletized to from the polymer pellets. Contact of the pellets with the aqueous treatment composition also treats the pellets to help protect against blocking, agglomeration, fouling and the like. Advantageously, use of the first surfactant component, and particularly the combination of the first and second surfactant components, allows the bath to be resistant to foaming as well.

After cooling and treating the pellets with an aqueous treatment composition of the present invention, the method may further comprise separating at least a portion of the treatment composition from at least a portion of the treated pellets. The separating may be performed by any suitable technique such as filtration, centrifuging, decanting, or any combination thereof. Advantageously, at least a portion of the treatment composition that is separated from the treated pellets may be reused to treat further pellets.

The separated pellets may still be wet with some of the treatment composition. Consequently, the method may further comprise drying the separated pellets. Drying may occur in any suitable manner such as, for example, in a centrifugal dryer.

For purposes of illustration, FIG. 1 schematically shows how principles of the present invention can be incorporated into a system 1 in which polymer material is pelletized, and the pellets are treated, further handled, stored, and distributed for further use or handling. In System 1, polymer 40 is fed into a screw extruder 10 along with additives 50 to be compounded into the polymer through the extruder action. The polymer is melted within the screw extruder 10 and extruded in molten form into pelletizer 20, where the polymer is cooled by combination and resulting contact with cooling water 260 and is pelletized to form polymer pellets 200. Generally, pelletizing causes the polymer to be cut, chopped, or otherwise separated into smaller, discrete pieces of polymer. The molten polymer 40 and/or resulting solid pellets 200, as the case may be, may be first contacted with the cooling water 260 before, during, and/or after pelletization. In illustrative modes of practice, the cooling water 260 will provide cooling to the molten polymer 40 in a manner effective to bring the polymer 40 below its melting point and also preferably below its softening point so that the previously molten polymer 40 becomes solid, thereby facilitating the pelletization process while the extruded polymer 40 is in solid form. Accordingly, preferably cooling water 260 contacts the extruded polymer 40 before and/or during pelletization. For example, the molten polymer 40 may be extruded into the cooling water 260 and pelletized therein. Alternatively, the molten polymer 40 may be subdivided into smaller portions and thereafter sufficiently cooled by contact with cooling water 260 to solidify the smaller portions into solid pellets 200. Since the cooling water also is an aqueous treatment composition of the present invention, the contact of pellets 200 with the cooling water 260 also treats the pellets 200 to protect them against blocking, agglomeration, fouling, etc.

An admixture comprising treated, solid pellets 200 and post-pelletization cooling water 190 flows to centrifugal dryer 60. The centrifugal dryer 60 separates pellets 200 from at least a portion, and desirably most of cooling water 190 by drying action to produce at least partially dried pellets 270. Some of the pellets 270 being dried may be separated as scrap 70 that might be discarded, recycled, and/or otherwise handled or processed. The remainder of the dried pellets 270 flow to classifier 120, where the pellets 270 may be sorted by size and whence the resulting classified pellets 280 are conveyed via check hopper 140 to silo 150, where additional drying and/or degassing of vapors 160 from the pellets may occur.

After separation from the dried pellets 270, separated cooling water 240 is recycled by being initially fed to water tank 90, where cooling water 240 may be combined with makeup water 80 to provide a reservoir of cooling water 250. The cooling water 240 may still hot from contacting and cooling the freshly extruded polymer 40. The resultant reservoir of cooling water 250 also may be hotter than desired for effective recycling back to the pelletizer 20. Accordingly, cooling water 250 is pumped by pump 230 from the water tank 90 to a heat exchanger 110, where the cooling water 250 is cooled to a suitable temperature to provide cooling water 260 in preparation for reuse to cool further molten polymer 40 in pelletizer 20. Accordingly, there is a circuit of cooling water (cooling liquid recirculation), which flows to the pelletizer 20, to dryer 60, to tank 90, heat exchanger 110, and back to pelletizer 20.

While most of the dried pellets 270 are separated from cooling water 240, some pellet material including at least a portion of fines (defined above) may still be entrained or otherwise carried in cooling water 240. Such entrained pellet material may travel with cooling water 240 to tank 90 and then to pump 230, heat exchanger 110, and back to pelletizer 20.

Untreated, dried polymer pellets in general and fines in particular may adhere to each other (blocking) as well to surfaces with which they come into contact. This is also true of pellets that are present within cooling water. Accordingly, in prior art processes, surfaces of the equipment in system 1 of FIG. 1 that contact the admixture of water and pellet material and/or dried pellet material may become fouled with polymer such as adherent fines. Such fouling and blocking reduce flow in the cooling water circuit and may impede or even block flow in the circuit of the cooling water. The flow of the solid polymer pellets also may be impeded. Accordingly, in prior art processes, the extrusion operation must be periodically shut down more often than desired to clean heat exchanger surfaces and other surfaces that become fouled. This reduces productivity and entails inconveniences associated with the cleaning process such as water and other material usage, thereby increasing costs due, for example, to lost productivity, and increased labor and materials costs. Also, untreated polymer material tends to require higher drying temperatures, which risks polymer degradation with increased temperature and/or increased residence time at higher temperature.

Advantageously, using treatment compositions of the present invention as cooling media in pelletization systems such as system 1 of FIG. 1 not only may reduce blocking and fouling, but also drying temperatures and/or residence time can be reduced to reduce the risk of polymer degradation.

Accordingly, the treatment compositions of the present invention as described herein may be combined and dispersed in the cooling water 260, 190, 240, and 250 to provide diluted treatment compositions of the present invention. As described above, a treatment composition of the present invention comprises an aqueous liquid carrier, the first surfactant component, and one or more optional ingredients that desirably include at least the second surfactant component. The first and second surfactants components, and any other components of the treatment composition, may be added together or separately to any one or more of the cooling water 260, 190, 240, and 250 at any convenient location or locations in the circuit of cooling water, whereby the cooling water functions not only to cool the polymer material but also is a treatment composition of the present invention. The components of the treatment composition may be added to the cooling water circuit at the same time and/or at different times from each other.

The components of the treatment composition may be added at the same location of the cooling water circuit or at separate locations. For example, as depicted in FIG. 1, first and second surfactant components may be added to the cooling water 250 in water tank 90 from supply tank 210 (comprising first surfactant component) and supply tank 220 (comprising second surfactant component) respectively. Optionally, one or more optional ingredients may be incorporated into the cooling water 250 as well. These additional optional ingredients, if any, may be provided in supply tank 210 and/or supply tank 220 or a separate tank (not shown). In other exemplary embodiments, the first and second surfactant components may both be added from a single supply tank (not shown). The composition in tank 210 comprising the first surfactant component may be in the form of an aqueous concentrate or as 100% actives (no aqueous carrier liquid, also referred to as being “neat”). The composition in tank 220 comprising the second surfactant component may be in the form of an aqueous concentrate, or as 100% actives.

Once the compositions from supply tanks 210 and 220 comprising the first and second surfactant components and any other components have been added to the cooling water 250, cooling water 250 becomes an aqueous treatment composition of the present invention. Combination of the compositions from tanks 210 and 220 results in dilution of those compositions. The surfactant components of the treatment composition thereby become incorporated into the cooling water 250, 260, etc., and the resultant aqueous treatment composition flows around the cooling-water circuit as cooling water.

When the first and second surfactant components are present within cooling water 250 and then the cooling water 260, the resultant pellets 200 become treated in a manner such that the degree of fouling and blocking may be reduced. Further, the treated pellets 200 can be dried at lower temperature and/or with reduced exposure to higher drying temperatures to reduce polymer degradation. As a further advantage, system 1 requires less maintenance such as cleaning of fouled heat exchanger, pipes, valves, and/or the like. Accordingly, productivity may be increased and labor costs reduced.

Furthermore, when the recirculating cooling water 260, 190, 240, and 250 constitutes a treatment composition of the present invention, pellets 200 including any fines are contacted by the treatment composition. After separation of pellets 270 from the cooling water 240 and drying the pellets, for example in the centrifugal dryer 60, the separated dried pellets 280 have been treated with the treatment composition, that is the pellets 280 have been contacted by the treatment composition and thereby are treated pellets. Treated pellets may be less prone to undue blocking and fouling than pellets that have not been treated with the treatment compositions of the invention. For example, the dried pellets 280 may flow more easily from dryer 60 to classifier 120, from classifier 120 to hopper 140, from hopper 140 to silo 150 where the pellets 280 are stored as pellets 290. Further, the flow of pellets 290 from silo 150, for example under gravity into railcar 180 or other type of further handling, may be improved. Additionally, the treated pellets 200 fed to dryer 60 are easier to dry (e.g., lower temperatures and/or reduced residence time may be used) to provide dried pellets 280. The lower temperatures required for drying the treated pellets may be less prone to cause undesirable heat-effected changes in the polymer pellets; for example, surface cracking, yellowing, degradation, and/or other undesirable effects. Without being bound by theory, it is believed that components of the treatment composition are retained on or otherwise incorporated onto or into the surface of the treated as a surface treatment (physical adherence) and/or surface modification (reactive modification) on dried pellets 280, thereby decreasing adhesion among pellets, lowering the surface energy of the interface of the pellets with air, and/or reducing fouling of surfaces contacted by the wet or dry pellets 200, 270, 280, and 290.

Untreated, flowable solid polymer bodies can adhere to or otherwise foul surfaces. Consequently, the movement of flowable solid polymer bodies relative to one or more surfaces may be impeded due to such fouling or adhesion of the flowable solid polymer bodies to themselves and/or the one or more surfaces.

Advantageously, the treatment of the pellets in accordance with the present invention helps with transport and storage. When the flowable solid polymer bodies have been treated by the treatment compositions of the invention, the blocking, agglomeration, and fouling tendencies are significantly reduced. For example, as one benefit, the flow of the flowable solid polymer bodies under a force, for example under gravity, relative to the surfaces may be improved.

Polymer body handling also is improved if surfaces contacting the pellets are treated in accordance with principles of the present invention. Even more desirably, both the pellets and the surfaces are treated using treatment compositions of the present invention. Any surface that contacts flowable, solid polymer bodies can benefit from the surface treatment. For example, the surface may be an interior surface of an apparatus such as a pelletizer, separator, dryer, or the like; piping through which wet or dried pellets are transported, a containment in which wet or dry pellets are stored such as a silo, or any other type of surface.

Therefore, a method of treatment of a surface comprises contacting the surface with an aqueous treatment composition of the present invention in a manner effective to provide a treated surface. The coating is caused or allowed to dry. Advantageously, the treated surface is more resistant to fouling as compared to an untreated surface. Without wishing to be bound, it is believed that a treated surface is coated with a coating comprising, consisting of, or consisting essentially of the first surfactant component, the second surfactant component if present, and one or more other optional ingredients if present. The aqueous treatment compositions used to treat or passivate surfaces in this way may be any of the aqueous treatment compositions of the present invention disclosed herein.

To prepare a treated surface, the step of contacting a surface with an aqueous treatment composition of the present invention may comprise, consist of, or consist essentially of applying the treatment composition to the surface by spray, roller, brush, curtain coating, immersion, or any other technique by which a layer, continuous or discontinuous, of the aqueous treatment composition may be deposited on the surface. After the aqueous treatment composition is applied to the surface to be treated, the resultant wet coating is allowed or caused to dry in order to provide the dried surface treatment.

The advantages of using treatment compositions of the present invention to treat (or passivate) surfaces will now be described in the illustrative context of using a resulting, treated containment to store flowable, solid polymer bodies. In preferred modes of practice, at least a portion of the surface(s) of the containment that contact the flowable solid polymer bodies as well as the flowable solid polymer bodies both are treated with treatment composition(s) of the present invention. While treated the surfaces of the containment may help to protect against fouling of the surfaces, treating both the containment and the flowable solid polymer bodies would provide even further protection against fouling as well as help make the flowable, solid polymer bodies more resistant to blocking with each other as well.

The method of using the treated containment may comprise disposing a plurality of flowable solid polymer bodies (treated or untreated, but preferably treated with a treatment composition of the present invention) into the interior volume defined by the containment. The flowable solid polymer bodies may be any of the flowable solid polymer bodies of the present invention as described hereinabove. As a result of the surface treatment of the containment, the stored flowable solid polymer bodies would show less of a tendency to foul or otherwise adhere to the containment surfaces. Consequently, the flowable, solid polymer bodies would be easier to dispense into the containment and easier to withdraw from the containment.

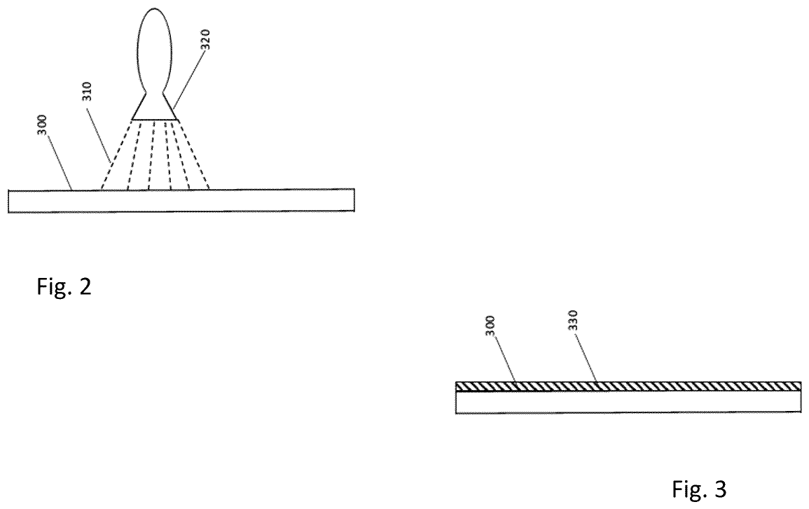

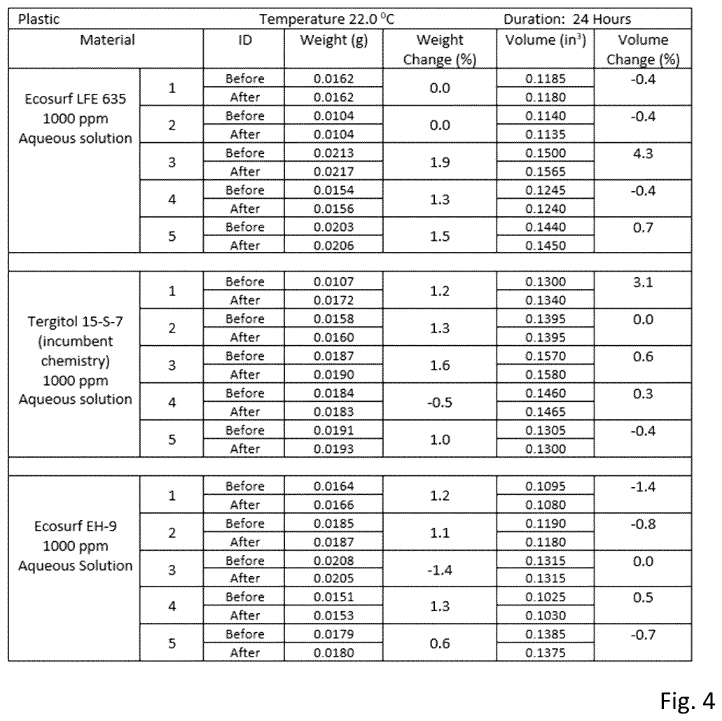

Exemplary embodiments of the method of treating a surface and then using the resultant treated surface will now be described in relation to FIG. 2 and FIG. 3, respectively. With reference to FIG. 4, an aqueous treatment composition of the present invention may be applied to surface 300 by any suitable application technique. For purposes of illustration, for example, spray 310 of the aqueous treatment composition is applied to surface 300 from nozzle 320. Surface 300 may be any surface that may come into contact with one or more flowable solid polymer bodies or the surface of a polymer body. While some previously known aqueous surfactant solutions, when sprayed or otherwise subject to shear or other agitating forces are often prone to undue foaming, advantageously, the aqueous treatment compositions of the invention could resist the formation of undue amounts of foam when sprayed. In other modes of practice, some degree of foaming may be desirable when spraying onto surfaces to be treated, as foamed material may be able to adhere better to the surfaces being treated rather than sheeting off before a desired degree of treatment results. Consequently, the application of spray 310 may occur under conditions effective to generate a foam that would adhere to the surface better than a less foamed or unfoamed embodiment. As an alternative, one or more optional additives can be incorporated into the treatment compositions in order to facilitate coating of the surface to be treated as opposed to applying spray material that unduly sheets off the surfaces too soon.

With reference to FIG. 2 and FIG. 3, surface 300 may be left to dry or otherwise caused to dry, such that water and any other volatile solvents (if present) evaporate and leave dried coating 330 as a surface treatment of the present invention on surface 300. Dried coating 330 may comprise the first nonionic surfactant, the second nonionic surfactant and one or more optional ingredients, if any.

Surface 300 may be any surface that may contact flowable polymer bodies as described herein. Non-limiting examples include surface(s) of containments, pelletizers, dryers, separators, distillation equipment, classifiers, heat exchangers, pumps, vanes, blades, conveyor surfaces, gauges, extruders, chutes, and the like. Non-limiting examples of containments include silos, pipes, railcars, tanks, classifiers, hoppers, bags, cartons, and the like.

The following illustrative examples are intended to further illustrate different aspects, features, and advantages of the present invention. In the following examples, the following materials were used, and distilled water was used:

| Trade name of | | |
|---|---|---|
| nonionic | | |
| surfactant | Commercial Source | Chemistry |
| Ecosurf LFE1410 | Dow Chemical Co. | Ethoxylated and propoxylated 2- |
| | | ethylhexanol according to Formula B |
| | | including on average 14 PO units and |
| | | 10 EO units per molecule (PO = 14, |
| | | EO = 10) |
| Ecosurf LFE635 | Dow Chemical Co. | Ethoxylated and propoxylated 2- |
| | | ethylhexanol according to Formula B |
| | | including on average 6 PO units and |
| | | 3.5 EO units per molecule (PO = 6, |
| | | EO = 3.5) |
| Ecosurf EH-9 | Dow Chemical Co. | Ethoxylated and propoxylated 2- |
| | | ethylhexanol according to Formula B |
| | | including on average 5 PO units and |
| | | 3.5 EO units per molecule (PO = 5, |
| | | EO = 9) |
| Ecosurf EH-14 | Dow Chemical Co. | Ethoxylated and propoxylated 2- |
| | | ethylhexanol according to Formula B |
| | | including on average 5 PO units and 14 |
| | | EO units per molecule (PO = 5, EO = |
| | | 14 |
| Ecosurf SA-9 | Dow Chemical Co. | Ethoxylated and propoxylated 2- |
| | | ethylhexanol according to Formula B |
| | | including on average 3 to 4 PO units |
| | | and 9 EO units per molecule and R is a |
| | | moiety containing 6 to 12 carbon |
| | | atoms (PO = 3 to 4, EO = 9; C6 to |
| | | C12) |
| Pluronic 25R2 | BASF | PO/EO/PO block polymer according to |
| | | Formula C, containing about 20 mole |
| | | % EO based on the total amount of PO |
| | | and EO. |
| Ecosurf LF-45 | Dow Chemical Co. | EO/BO alkoxylate of a C12-C14 |
| | | alcohol according to Formula E |
| Tergitol 15-S-9 | Dow Chemical Co. | ethoxylated C12-C14 secondary |
| | | alcohol according to Formula D |
| | | containing 9 EO moles per molecule |
| | | on average |
| Tergitol 15-S-12 | Dow Chemical Co. | ethoxylated C12-C14 secondary |
| | | alcohol according to Formula D |
| | | containing 12 EO moles per |
| | | molecule on average |
| Tergitol 15-S-15 | Dow Chemical Co. | ethoxylated C12-C14 secondary |
| | | alcohol according to Formula D |
| | | containing 15 EO moles per molecule |
| | | on average |
| Tergitol 15-S-7 | Dow Chemical Co. | ethoxylated, secondary C12-C14 |
| (also referred to | | alcohol according to Formula D with |
| herein as EC | | an average of about 7 EO units per |
| 9440D) | | molecule |
| Plurafac LF 224 | BASF | Butoxylated and ethoxylated |
| (also referred to as | | unbranched C10-C16 alcohol |
| Plurafac 224 | | according to Formula E |
| herein) | | |
| EC9092A | Cayman Chemical Co. | ethoxylated hydrophobic alcohol |
| EC9052A | Cayman Chemical Co. | polydimethyl siloxane in admixture |
| | | with a silica sol (antifoaming agent) |

### Example 1

### Foam Testing According to ASTM D-892

Foaming characteristics of nonionic surfactants were evaluated in accordance with the standard test procedure in accordance with a modified version of ASTM D-892. A 0.1 wt % (1000 ppm by weight) aqueous, stock solution of TERGITOL 15-S-7 in water was made. Further samples also were prepared in which each sample included 1000 ppm of a particular EO/PO nonionic surfactant in water. A further sample included 1000 ppm of the EC9092A surfactant in water.

Each sample was provided in a 1000 ml graduated cylinder. Nitrogen gas was bubbled through each sample at a flow rate of 725 mL/minute. The foam height in the graduated cylinder was measured at time intervals of 15, 30, 45, 60, 75, 90, and 120 seconds after nitrogen flow was started. The foam height was taken as the location of the top of the foam in the graduated cylinder. The compositions of the samples are summarized in TABLE 1.

| | Composition (1000 ppm by weight of each listed |
|---|---|
| Sample No. | nonionic surfactant in water) |
| 1 | Tergitol 15-S-7 |
| 2 | EC9092A |
| 3 | Ecosurf LF-45 |
| 4 | Ecosurf EH-9 |
| 5 | Pluronic 25R2 |
| 6 | Ecosurf LFE1410 |
| 7 | Ecosurf LFE 635 |

Samples 1, 2, and 3 showed the most initial foaming and the most foaming as the test progressed. The foaming as a function of time for Samples 1, 2, and 3 was similar. Foaming after 15 seconds was in the range from about 200 to almost 300 ml for these samples. The amount of foaming increased to about 400 ml, about 600 ml, about 600 ml to 800 ml, about 800 ml to about 1000 ml, about 900 ml to 1000 ml, about 1000 ml, and about 1000 ml at 30 seconds, 45 seconds, 60 seconds, 75 seconds, 90 seconds, 105 seconds, and 120 seconds, respectively.

Although Sample 4 showed almost similar foaming (about 150 ml) to Samples 1, 2, and 3 after 15 seconds, Sample 4 showed reduced foaming as the test progressed compared to Samples 1, 2 and 3. Sample 4 showed foaming of about 200 ml, about 300 ml, about 400 ml, about 500 ml, about 600 ml, and about 750 ml at 30 seconds, 45 seconds, 60 seconds, 75 seconds, 90 seconds, 105 seconds, and 120 seconds, respectively.

Samples 5 to 7 showed even less foaming than any of the other samples throughout the test. At all the time intervals, foaming for Samples 5 to 7 was about 50 ml or less.

### Example 2

### Foam Testing According to ASTM 892

The procedure of Example 1 is repeated to again test compositions according to Samples 2, 4, 5, and 7 to help assess if the foaming characteristics would be repeatable. Again, sample 2 showed higher initial foaming after 15 seconds and much more foaming as the test progressed. Sample 2 showed over 200 ml of foaming after 15 seconds, and the foaming increased to about 1000 ml from 90 seconds to 120 seconds. In contrast, all of the other samples showed much less foaming throughout the test. Samples 4, 5, and 7 all showed initial foaming of 50 ml or less at 15 seconds. Sample 4 reached about 100 ml at 45 seconds and generally stayed at this level for the remainder of the test. Samples 5 and 7 showed under about 50 ml of foaming throughout the test.

### Example 3

### Foam Testing in Bottles

Surfactant solutions containing 1000 ppm nonionic surfactant in water were placed in similarly sized, sealed glass jars such that the glass jars were about half full of the surfactant solution. The jars were vigorously shaken. All of the jars showed foaming immediately after being shaken. The jars were observed over time for time periods ranging from 5 minutes to several hours to evaluate foam dissipation. The Ecosurf EH-9, Ecosurf SA-9, Ecosurf EH-14, LF-45, Ecosurf LFE635, Tergitol 15-S-7, Pluronic 25R2, Ecosurf LFE1410, Tergitol 15-S-9, Tergitol 15-S-12, and Tergitol 15-S-15 surfactants were evaluated.

In one evaluation, the sample with Tergitol 15-S-7 surfactant was compared to the samples with the Pluronic 25R2 and Ecosurf LFE 1410 surfactants. Even after several hours, the foam of the Tergitol 15-S-7 sample substantially persisted. After this same time period, no foam was observed in the other samples.

In an evaluation of the samples containing Ecosurf EH-9, Ecosurf SA-9, Ecosurf EH-14, and Ecosurf LF-45 nonionic surfactants, only 10% to 30% of the initial foam for each sample persisted after 1 hour.

In another evaluation, the foaming characteristics of samples including the Tergitol 15-S-9, Tergitol 15-S-12, and Tergitol 15-S-15 surfactants was compared to that of a sample including the LFE635 surfactant. After 3 hours, the foam of the samples including the Tergitol 15-S-9, Tergitol 15-S-12, and Tergitol 15-S-15 surfactants substantially persisted. In contrast, the sample with the Ecosurf LFE 635 surfactant showed mild haze but no foam after this time period.

### Example 4

### Impact on Pellets

The impact of three kinds of surfactant treatments on the melting point of commercially procured polymer pellets was evaluated. EO/PO nonionic surfactants available under the tradenames Pluronic 25R2, Ecosurf LFE 635 and Ecosurf EH-9 were tested. For comparison, an EO nonionic surfactant available under the tradename Tergitol 15-S-7 also was tested. Also, untreated pellets were tested for comparison. Melting points of the polymer pellet samples were tested before and after the treatments. For each type of nonionic surfactant and the sample with no treatment, 5 polymer pellets were tested. Each pellet was placed into a jar containing a solution of 1000 ppm by weight of the surfactant in water, except that the jars for the untreated sample pellets had no surfactant. Thus, 5 jars, each containing a single pellet, were tested for each surfactant and the blank, respectively. The immersed pellets were held in the jars at ambient temperature (about 22° C.) for about 24 hours. After this exposure time, the pellets were collected, quickly rinsed with DI water, and then allowed to dry under ambient conditions for about 16 hours.

The weight and volume of the pellets before and after the treatment was measured with respect to pellets treated with Tergitol 15-S-7, Ecosurf LFE 63.5 and Ecosurf EH-9. A table of the weight and volume data is shown in FIG. 4.

The melting points of the pellets before and after the immersion treatment were measured using DSC techniques by increasing the temperature at a rate of 10° C. per minute up to 200° C. All of the sample pellets showed similar melting points before and after immersion, within experimental error.

The pellets also were visually inspected under a microscope. Visual inspection under microscope showed no cracking, crazing, or swelling for any pellet tested.

The data as a whole shows that properties of the polymer pellets are substantially unaffected by the surfactant treatments.

### Example 5

### Surface Tension

Surface tension is tendency of liquid surfaces at rest to shrink into the minimum surface area possible. Lowering surface tension of water is hypothesized to increase wettability, hydrophobicity on surface of pellets to prevent agglomeration. A decrease in the cohesive force (surface tension) within the liquid would result in greater wettability and a smaller contact angle with respect to polymer pellets.

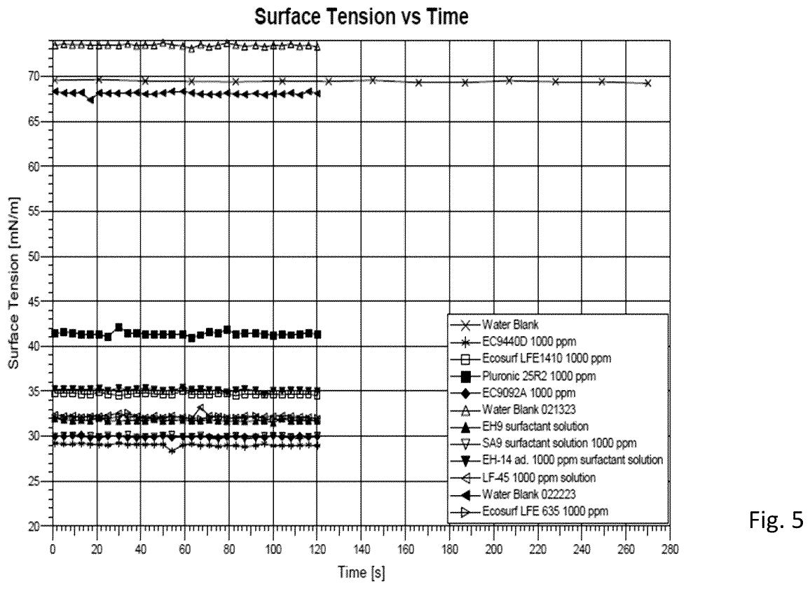

Consequently, the surface tension characteristics of nonionic surfactants in water were evaluated by tensiometer according to ASTM D 1331 C/D. Each sample included 1000 ppm by weight of a particular nonionic surfactant in water. Water alone as a reference sample also was tested. Samples were tested at 25° C. The tensiometer tests were performed on Kruss 100 tensiometer instrument with platinum Wilhelmy plate. The data is obtained in dynes/cm or mN/m (milli Newton/meter). The surface tension was measured as a function of time. The surface tension of the tested materials as a function of time is shown in FIG. 5.

### Example 6

### Cloud Points

Cloud points (in degrees Celsius, ° C.) of surfactant solutions containing 1000 ppm by weight of surfactant in water were experimentally determined in accordance with ASTM D2024 (2017) and compared to cloud points provided on data sheets by the vendor. The results are shown in the following Table 6A:

TABLE 6A

| Surfactant (1000 ppm by weight | Experimental Cloud | Datasheet Cloud |
|---|---|---|
| in water) | Point (° C.) | Point (° C.) |
| Tergitol 15-S-7 | 34 | 37 |
| Ecosurf LFE 635 | 18 | 35 |
| Pluronic 25R2 | 35 | 27-32 |
| Ecosurf EH-9 | 31 | 61 |
| Ecosurf LF-45 | 41 | 46 |

The experimental cloud points for the Ecosurf LFE 635 and Ecosurf EH-9 as reported in Table 6A differed significantly from the cloud point data on the vendor data sheet. It is believed that the variance was due to an error in conducting the measurements. The measurements were re-taken for these, and the results are shown in Table 6B:

TABLE 6B

| | Remeasured | |
|---|---|---|
| Surfactant (1000 ppm by weight | Experimental Cloud | Datasheet Cloud |
| in water) | Point (° C.) | Point (° C.) |
| Ecosurf LFE 635 | 35 | 35 |
| Ecosurf EH-9 | 65 | 61 |

### Example 7

### Pellet Soak Tests

Pellet soak tests were performed by immersing and soaking polymer pellets in surfactant solutions containing 1000 ppm by weight surfactant in water for 24 hours. For comparison, a “blank” sample was evaluated in which pellets also were immersed and soaked in water with no surfactant. After the soaking period, the pellets were filtered and dried and evaluated for clumping, swelling, and changes in shape or color. EO/PO nonionic surfactants tested included Ecosurf LFE 1410, Ecosurf LFE 635, Pluronic 25R2. For comparison to evaluate if the EO/PO nonionic surfactants can mimic other kinds of surfactants in terms of compatibility with polymer pellets, the EC9440D and EC9092A surfactants also were tested.

In all samples, no clumping was observed. Also, no physical changes were observed after the soak tests for any of the samples.

What is claimed is:

1. A method of treating a plurality of solid polymer bodies, comprising the step of causing the plurality of solid polymer bodies to contact an aqueous treatment composition, wherein the aqueous treatment composition comprises:
a) an aqueous liquid carrier;
b) a first surfactant component comprising at least one EO/PO nonionic surfactant comprising a hydrophobic moiety, a plurality of ethylene oxide groups, and a plurality propylene oxide groups, wherein the at least one EO/PO nonionic surfactant comprises 5 weight percent or more of the propylene oxide groups based on the total weight of the EO/PO nonionic surfactant; and
c) a second surfactant component comprising at least one EO nonionic surfactant comprising a hydrophobic moiety and a plurality of ethylene oxide groups, wherein the at least one EO nonionic surfactant is free of propylene oxide groups; and
wherein the aqueous treatment composition is at a temperature below the solid transition temperature associated with the plurality of solid polymer bodies.

2. The method of claim 1, wherein the aqueous treatment composition is at a temperature in the range from 20° C. to 90° C.

3. The method of claim 1, wherein the aqueous treatment composition is at a temperature in the range from 25° C. to 60° C.

4. The method of claim 1, wherein the weight ratio of the first surfactant component to the second surfactant component is in the range from 1:20 to 20:1.

5. The method of claim 1, wherein the weight ratio of the first surfactant component to the second surfactant component is in the range from 5:2 to 2:1.

6. The method of claim 1, wherein the molar ratio of the propylene oxide groups to the ethylene oxide groups in the first nonionic surfactant is greater than 1.

7. The method of claim 1, wherein the aqueous liquid carrier has a cloud point of 60° C. or higher.

8. The method of claim 1, wherein the aqueous liquid carrier has a cloud point of 90° C. or higher.

9. The method of claim 1, wherein the polymer bodies include a plurality of solid polymer pellets having an associated solid transition temperature, and wherein the method further comprises the steps of:
a) prior to the step of causing the plurality of polymer bodies to contact the aqueous treatment composition, introducing one or more molten polymer strands into the aqueous treatment composition, wherein the aqueous treatment composition at the time of said introducing is at a temperature sufficiently below the associated solid transition temperature so as to be effective to cause the one or more molten polymer strands to solidify in the aqueous treatment composition; and
b) pelletizing the one or more solidified polymer strands to form the plurality of solid polymer pellets.

10. The method of claim 1, wherein the first nonionic compound has the formula
R^{H}—(PO)ₘ-(EO)ₙ—R^{T}
wherein RH is H or a hydrophobic organic moiety comprising 6 to 50 carbon atoms, R^{T} is a monovalent terminal moiety, and each of m and n is independently in the range from 2 to 30.

11. The method of claim 10, wherein R comprises 8 to 20 carbon atoms.

12. The method of claim 11, wherein R is a residue of a fatty alcohol comprising a branched hydrocarbyl moiety.

13. The method of claim 11, wherein the first nonionic compound has a formula as follows, wherein each of m and n independently is in a range from 8 to 20:

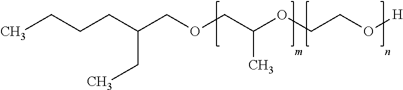

14. The method of claim 13, wherein m is 4 to 6 and n is 3 to 15.

15. The method of claim 14, wherein m is 4 to 6 and n is 3 to 9.

16. The method of claim 13, wherein m is 4 to 6 and n is 3 to 5, and wherein m is greater than n.

17. The method of claim 1, wherein the first nonionic compound has the formula
R^{H}—(PO)ₘ-(EO)ₙ—(PO)ₚ—R^{T}
wherein RH is H or a hydrophobic organic moiety comprising 6 to 50 carbon atoms, R^{T} is a monovalent terminal moiety, and each of m, n, and p is independently in the range from 2 to 30.

18. The method of claim 17, wherein R comprises 8 to 20 carbon atoms.

19. The method of claim 18, wherein R is a residue of a fatty alcohol comprising a branched hydrocarbyl moiety.

20. The method of claim 19, wherein the branched hydrocarbyl moiety is 2-ethylhexyl.

21. The method of claim 17, wherein each of m, n, and p independently is in the range from 12 to 25 subject to the proviso that the molar ratio of the PO groups to the EO groups is greater than 1.

22. The method of claim 19, wherein m is in the range from 18 to 22, n is in the range from 12 to 16, and p is in the range from 18 to 22.

23. The method of claim 22, wherein m is 21, n is 14, and p is 21.

24. The method of claim 1, wherein the second nonionic surfactant further comprises a plurality of butylene oxide groups.

25. The method of claim 1, wherein the second surfactant component comprises a) an ethoxylated fatty alcohol, and b) a butoxylated and ethoxylated fatty alcohol.

26. The method of claim 1, wherein the aqueous treatment composition further comprises a polysiloxane ingredient.

27. A method of treating a plurality of polymer bodies having an associated solid transition temperature, comprising the step of causing the plurality of polymer bodies to contact an aqueous treatment composition, wherein the aqueous treatment composition comprises:
a) an aqueous liquid carrier; and
b) a first surfactant component comprising at least one EO/PO nonionic surfactant comprising a hydrophobic moiety, a plurality of ethylene oxide groups, and a plurality propylene oxide groups, wherein the molar ratio of the propylene oxide groups to the ethylene oxide groups is greater than 1, and wherein the at least one EO/PO nonionic surfactant comprises 5 weight percent or more of the propylene oxide groups based on the total weight of the EO/PO nonionic surfactant; and
wherein the aqueous treatment composition is at a temperature below the solid transition temperature associated with the plurality of solid polymer bodies.

28. A method of making solid polymer pellets having an associated solid transition temperature, comprising the steps of:
a) introducing one or more molten polymer strands into a volume comprising an aqueous composition, wherein the aqueous composition comprises an aqueous liquid carrier and a first surfactant component comprising at least one EO/PO nonionic surfactant comprising a hydrophobic moiety, a plurality of ethylene oxide groups, and a plurality of propylene oxide groups, wherein the aqueous treatment composition at the time of said introducing is at a temperature sufficiently below the associated solid transition temperature so as to be effective to cause the one or more molten polymer strands to solidify in the aqueous treatment composition, and wherein the at least one EO/PO nonionic surfactant comprises 5 weight percent or more of the propylene oxide groups based on the total weight of the at least one EO/PO nonionic surfactant; and
b) while the one or more solidified polymer strands are in the volume comprising the aqueous composition, pelletizing the one or more solidified polymer strands.

29. A storage system, comprising:
a) a storage vessel comprising an internal surface defining at least a portion of a storage volume, wherein the surface includes a surface treatment comprising a first surfactant component, wherein the first surfactant component comprises at least one EO/PO nonionic surfactant, wherein the at least one EO/PO nonionic surfactant comprises a hydrophobic moiety, a plurality of ethylene oxide groups, and a plurality of propylene oxide groups, and wherein the at least one EO/PO nonionic surfactant comprises 5 weight percent or more of the propylene oxide groups based on the total weight of the at least one EO/PO nonionic surfactant; and
b) a plurality of polymer bodies held in the storage volume such that at least a portion of the polymer bodies contact the internal surface.

30. A method of storing polymer bodies, comprising the steps of:
a) providing a storage vessel comprising an internal surface defining at least a portion of a storage volume, wherein the internal surface includes a surface treatment comprising a first surfactant component, wherein the first surfactant component comprises at least one EO/PO nonionic surfactant that comprises a hydrophobic moiety, a plurality of ethylene oxide groups, and a plurality of propylene oxide group, and wherein the at least one EO/PO nonionic surfactant comprises 5 weight percent or more of the propylene oxide groups based on the total weight of the at least one EO/PO nonionic surfactant; and
b) holding a plurality of polymer bodies in the storage volume such that at least a portion of the polymer bodies contact the internal surface.
